(19) United States
(12) Patent Application Publication
(10) Pub. No.: US 2026/0097684 A1
(43) Pub. Date: Apr. 9, 2026

(54) SYSTEMS AND METHODS FOR OPTIMAL ENERGY MANAGEMENT BASED ON TIME SERIES FORECASTING OF POWER LOAD

(71) Applicants: Ohio State Innovation Foundation, Columbus, OH (US); PACCAR Inc, Bellevue, WA (US)

(72) Inventors: Satvik KHUNTIA, Bellingham, WA (US); Athar HANIF, Columbus, OH (US); Qadeer AHMED, Plain City, OH (US); Maarten MEIJER, Anacortes, WA (US); Charles SWART, Bellilngham, WA (US); John LAHTI, Anacortes, WA (US); Iner JORGENSEN, Renton, WA (US); Shweta HARDAS, Snohomish, WA (US)

(21) Appl. No.: 19/113,690

(22) PCT Filed: Sep. 21, 2023
(86) PCT No.: PCT/US2023/033344

§ 371 Date: Mar. 20, 2025

Related U.S. Application Data
(60) Provisional application No. 63/408,626, filed on Sep. 21, 2022.

(51) Int. Cl. B60L 58/12; G06N 3/0442; G06Q 10/04; G06Q 50/06; G06Q 50/40

(52) U.S. Cl. CPC B60L 58/12; G06N 3/0442; G06Q 10/04; G06Q 50/06; G06Q 50/40; B60L 2200/36; B60L 2260/46; B60Y 2200/91; B60Y 2200/92

(57) ABSTRACT

An example method of optimized energy management includes creating a synthetic training dataset, where the synthetic training dataset includes a activity profiles for a period of time; training a deep learning model using the synthetic training dataset; predicting, using the trained deep learning model, a power load for the period of time; determining a projected state of charge (SOC) of an energy storage device during the period of time based, at least in part, on the predicted power load; and controlling charging operations for the energy storage device based on the projected SOC.

### CROSS-REFERENCE TO RELATED APPLICATIONS

This application claims the benefit of U.S. provisional patent application No. 63/408,626, filed on Sep. 21, 2022, and titled “CABIN LOAD PREDICTION USING TIME SERIES FORECASTING FOR LONG HAUL TRUCKS FOR OPTIMAL ENERGY MANAGEMENT,” the disclosure of which is expressly incorporated herein by reference in its entirety.

### STATEMENT REGARDING FEDERALLY FUNDED RESEARCH

This invention was made with government support under DE-EE0008265 awarded by the Department of Energy. The government has certain rights in the invention.

### BACKGROUND

Long-haul trucks are a major form of transportation, and consume significant amounts of energy. A long-haul truck can be used in trips that last multiple days, and a driver may live aboard the truck during the trip. When a driver lives aboard a truck, it can be referred to as “hoteling,” and the electric usage during hoteling can be referred to as “cabin loads.” Currently, many long haul trucks run on diesel fuel, which can be a significant emitter of CO2 and other types of pollution. Hoteling can add to these emissions because drivers can use appliances, HVAC (heating, ventilation and air conditioning) systems, entertainment devices, and other electrical devices. Drivers may need to run the diesel truck engine to supply these loads, which generates additional emissions.

Hybrid and electric power trains can be used to replace and/or supplement existing diesel power trains on long haul trucks. These hybrid and electric power trains include energy storage systems (e.g., batteries) that can be used to propel the truck using the stored energy. These energy storage systems can also be adequate to supply power for cabin loads during hoteling periods. To rely on the energy storage systems during hoteling periods, the energy storage systems must be charged sufficiently to supply the cabin loads.

### SUMMARY

Systems and methods for performing optimized energy management are described herein. In some implementations described herein, the systems and methods can be used to optimize energy management in a long-haul truck so that an energy source (e.g., a battery) has enough energy to supply the cabin loads of the long-haul truck during a hoteling period.

In some aspects, the techniques described herein relate to a method of optimized energy management, the method including: creating a synthetic training dataset, wherein the synthetic training dataset includes a plurality of activity profiles for a period of time; training a deep learning model using the synthetic training dataset; predicting, using the trained deep learning model, a power load for the period of time; determining a projected state of charge (SOC) of an energy storage device during the period of time based, at least in part, on the predicted power load; and controlling charging operations for the energy storage device based on the projected SOC.

In some aspects, the techniques described herein relate to a method, wherein the deep learning model includes a recurrent neural network.

In some aspects, the techniques described herein relate to a method, wherein the deep learning model includes a long short term memory (LTSM) model.

In some aspects, the techniques described herein relate to a method, wherein controlling charging operations for the energy storage device based on the projected SOC includes controlling a vehicle engine.

In some aspects, the techniques described herein relate to a method, wherein creating a synthetic dataset includes generating the plurality of activity profiles from a base dataset.

In some aspects, the techniques described herein relate to a method, wherein each of the plurality of activity profiles includes sleep activity data and energy usage data.

In some aspects, the techniques described herein relate to a method wherein each of the plurality of activity profiles includes a time allocation matrix (TAM), wherein the TAM includes temporal activity information.

In some aspects, the techniques described herein relate to a method, wherein each of the plurality of activity profiles includes a transition matrix (TM), wherein the TM includes relational activity information.

In some aspects, the techniques described herein relate to a method, wherein each of the plurality of activity profiles includes a power load profile.

In some aspects, the techniques described herein relate to a method, wherein the energy storage device is one or more batteries.

In some aspects, the techniques described herein relate to a method—10 wherein the period of time is a hotel period for a long-haul vehicle driver.

In some aspects, the techniques described herein relate to a method, further including predicting an HVAC load, and wherein the predicted power load is based at least in part on the HVAC load.

In some aspects, the techniques described herein relate to a method, wherein the step of determining a projected SOC includes using dynamic programming to determine the projected SOC using the HVAC load and the predicted power load.

In some aspects, the techniques described herein relate to a system for optimized energy management, the system including: a vehicle including an energy storage device, a vehicle controller, and an engine; an energy management controller operably coupled to the vehicle, the energy management controller including a processor and a memory, the memory having computer-executable instructions stored thereon that, when executed by the processor, cause the processor to: create a synthetic training dataset, wherein the synthetic training dataset includes a plurality of activity profiles for a period of time; train a deep learning model using the synthetic training dataset; predict, using the trained deep learning model, a power load for the period of time; determine a projected state of charge (SOC) of an energy storage device during the period of time based, at least in part, on the predicted power load; and transmit the projected SOC to the vehicle controller, wherein the vehicle controller is configured to control charging operations for the energy storage device based on the projected SOC.

In some aspects, the techniques described herein relate to a system, wherein the deep learning model includes a recurrent neural network.

In some aspects, the techniques described herein relate to a system, wherein the deep learning model includes a long short term memory (LTSM) model.

In some aspects, the techniques described herein relate to a system, wherein the vehicle controller is configured to control charging operations for the energy storage device based on the projected SOC by controlling a vehicle engine.

In some aspects, the techniques described herein relate to a system, wherein creating a synthetic dataset includes generating the plurality of activity profiles from a base dataset.

In some aspects, the techniques described herein relate to a system, wherein each of the plurality of activity profiles includes sleep activity data and energy usage data.

In some aspects, the techniques described herein relate to a system, wherein each of the plurality of activity profiles includes a time allocation matrix (TAM), wherein the TAM includes temporal activity information.

In some aspects, the techniques described herein relate to a system, wherein each of the plurality of activity profiles includes a transition matrix (TM), wherein the TM includes relational activity information.

In some aspects, the techniques described herein relate to a system, wherein each of the plurality of activity profiles includes a power load profile.

In some aspects, the techniques described herein relate to a system, wherein the energy storage device is one or more batteries.

In some aspects, the techniques described herein relate to a system, wherein the period of time is a hotel period for a long-haul vehicle driver.

In some aspects, the techniques described herein relate to a system, wherein the energy management controller is operably coupled to the vehicle over a communication network.

In some aspects, the techniques described herein relate to a system, further including predicting an HVAC load, and wherein the predicted power load is based at least in part on the HVAC load.

In some aspects, the techniques described herein relate to a system, wherein the projected SOC is determined using dynamic programming based on the HVAC load and the predicted power load.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates an example method of optimized energy management, according to implementations of the present disclosure.

FIG. 1B illustrates an example method of optimized energy management, according to implementations of the present disclosure.

FIG. 2 illustrates a system for optimized energy management, according to implementations of the present disclosure.

FIG. 3 illustrates an example computing device.

FIG. 4 illustrates an example load profile for a driver during a hotel period.

FIG. 5 illustrates an example power load profile for an example 10 hour hotel load period.

FIG. 6 illustrates an example plot of sleep duration distributions for drivers on long-haul truck trips.

FIG. 7 illustrates an example method of performing prediction.

FIG. 8 illustrates an example time allocation matrix for a hotel period.

FIG. 9 illustrates an example Euclidian distance comparison for an algorithm trained over test periods and hidden units.

FIG. 10A illustrates an example predicted power load profile.

FIG. 10B illustrates an example test day load profile.

FIG. 11 illustrates an example schematic of load prediction and energy estimation for a truck.

FIG. 12 illustrates an example schematic for a cabin HVAC system in a truck.

FIG. 13 illustrates an example plot of temperature for various components of an example truck as a function of time.

FIG. 14A illustrates an example of cabin temperature error in an experiment compared to a simulation.

FIG. 14B illustrates an example of temperature difference for the experiment shown in FIG. 14A.

FIG. 14C illustrates an error histogram for the experiment shown in FIGS. 14A and 14B.

FIG. 14D illustrate an example of window temperature error in an experiment compared to a simulation.

FIG. 14E illustrates an example of temperature difference for the experiment shown in FIG. 14D.

FIG. 14F illustrates an error histogram for the experiment shown in FIGS. 14D-14E.

FIG. 15A illustrates an example of cabin temperature error in an experiment compared to a simulation.

FIG. 15B illustrates an example of temperature difference for the experiment shown in FIG. 15A.

FIG. 15C illustrates an error histogram for the experiment shown in FIGS. 15A and 15B.

FIG. 15D illustrate an example of window temperature error in an experiment compared to a simulation.

FIG. 15E illustrates an example of temperature difference for the experiment shown in FIG. 15D.

FIG. 15F illustrates an example of roof temperature error for a simulation compared to an experiment.

FIG. 15G illustrates an example of temperature difference for the experiment shown in FIG. 15F.

FIG. 15H illustrates an example error histogram for the results shown in FIGS. 14F and 15G.

FIG. 16 illustrates a comparison of an example 2-node and an example 3-node model.

FIG. 17 illustrates a comparison of an example 2-node and an example 3-node model with different data used.

FIG. 18 illustrates example temperature profiles with simulated vs. experimental data.

FIG. 19 illustrates an example vapor compression cycle.

FIG. 20 illustrates an example vapor compression cycle plotted on a P-h graph.

FIG. 21 illustrates example plots of test data temperature as a function of time.

FIG. 22A illustrates example evaporator flow rates.

FIG. 22B illustrates example condenser flow rates.

FIG. 22C illustrates example coolant flow rates.

FIG. 23A illustrates a calibrated evaporator model comparison on initial no-flow data.

FIG. 23B illustrates a calibrated evaporator model comparison on transient data.

FIG. 23C illustrates a calibrated evaporator model comparison on flow rate oscillating data.

FIG. 23D illustrates a calibrated evaporator model comparison on steady state data.

FIG. 24A illustrates a calibrated evaporator model comparison on initial no-flow data.

FIG. 24B illustrates a calibrated evaporator model comparison on transient data.

FIG. 24C illustrates a calibrated evaporator model comparison on flow rate oscillating data.

FIG. 24D illustrates a calibrated evaporator model comparison on steady state data.

FIG. 25 illustrates an RMSE error analysis of example data using two different calibrations.

FIG. 26A illustrates experimental data compared to an example model for a first data segment.

FIG. 26B illustrates an error histogram for the comparison illustrated in FIG. 26A.

FIG. 26C illustrates experimental data compared to an example model for a second data segment.

FIG. 26D illustrates an error histogram for the comparison illustrated in FIG. 26C.

FIG. 26E illustrates experimental data compared to an example model for a third data segment.

FIG. 26F illustrates an error histogram for the comparison illustrated in FIG. 26E.

FIG. 27 illustrates a comparison of RMSE error for models of example condenser pressures.

FIG. 28A illustrates experimental data compared to an example model for a first data segment.

FIG. 28B illustrates an error histogram for the comparison illustrated in FIG. 26A.

FIG. 28C illustrates experimental data compared to an example model for a second data segment.

FIG. 28D illustrates an error histogram for the comparison illustrated in FIG. 26C.

FIG. 28E illustrates experimental data compared to an example model for a third data segment.

FIG. 28F illustrates an error histogram for the comparison illustrated in FIG. 26E.

FIG. 29A illustrates an example model compared to an experiment.

FIG. 29B illustrates an example model compared to an experiment, using a different model calibration from the model shown in FIG. 29A.

FIG. 30 illustrates example efficiency values at a compressor.

FIG. 31A illustrates an example map of mechanical and electrical efficiency for a compressor.

FIG. 31B illustrates an example map of volumetric efficiency for a compressor.

FIG. 31C illustrates an example of isotropic efficiency for a compressor.

FIG. 32 illustrates an example block diagram of a simulator for an cabin HVAC in a truck.

FIG. 33A illustrates an example of heat exchanger pressure over time.

FIG. 33B illustrates an example of cabin temperature profiles over time.

FIG. 33C illustrates an example of battery power demanded over time.

FIG. 34 illustrates an example optimal state of charge trajectory for a one day driving and hoteling cycle.

FIG. 35 illustrates an example system configured to estimate a load cycle based on user activity prediction and estimate HVAC load cycle information, according to implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for predicting energy consumption in vehicles, it will become evident to those skilled in the art that the implementations are not limited thereto, but are applicable for predicting energy use in different scenarios and contexts.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Long haul journeys in trucks can take up to a few days and the driver spends 10 hours resting inside the cabin after every 11 hours driving. This 10 hour rest period is referred to herein as the hoteling period, although it should be understood that 10 hours is only an example, and that the systems and methods described herein can be used with any length of hoteling period. Sleeper cabs are used for this application and are equipped with devices like microwaves, coffee makers, lights, etc. for the driver to have a comfortable rest inside the truck anywhere along the route. The driver uses some of these devices based on the need, for example, the driver uses a microwave when they want to cook/heat food, and a coffee maker when they want to drink coffee. These devices have a rated power that they draw when being used. This power draw is highly subjective to driver behavior (what devices does the driver use and how many times). With the advent of hybrid electric and battery electric trucks, it has become immensely important to have enough battery energy stored in the battery pack before the hoteling period since battery packs are the only source of power unlike internal combustion engines and the drivers cannot be left with no power in the battery when they are hoteling. Since federal laws mandate the drivers to rest for 10 hours after every 11 hours of driving, sometimes the drivers may not be near a truck stop (i.e., near a grid-based power source) and would need to start their hoteling period. This generates a need for the driver to have sufficient energy stored in the trucks' battery to supply the cabin loads during the hotel period.

Implementations of the present disclosure include methods of optimized energy management. The methods described herein can be used to train deep learning models to perform optimized energy management using synthetic data. Using synthetic data can overcome the limitations of existing training methods, which can require large amounts of real-world data. Real-world systems, however, may not be configured to generate real-world data (for example, they may lack sensors, data storage, and/or networking capabilities). Thus, the use of synthetic data for training allows for the training of deep learning models for optimized energy management in situations where real-world data is not available. For example, there is no existing dataset for cabin loads during hoteling periods that can be used to train a deep learning model. Real-world data, even if it exists, would not include a sufficiently large number of samples, and much less data would lack diversity. The present disclosure describes techniques for generating synthetic data, which includes but is not limited to generating activity profiles. Such activity profiles include temporal and relational energy usage data as well as sleep activity data during hoteling periods. The synthetic data created according to this disclosure addresses challenges unique to the cabin load during hoteling application (e.g., time series forecasting of load) and results in a dataset representative of real-world data. Thus, the present disclosure contemplates that deep learning models trained with such a synthetic training dataset will have better accuracy, have less tendency to overfit, and better generalize to unseen data.

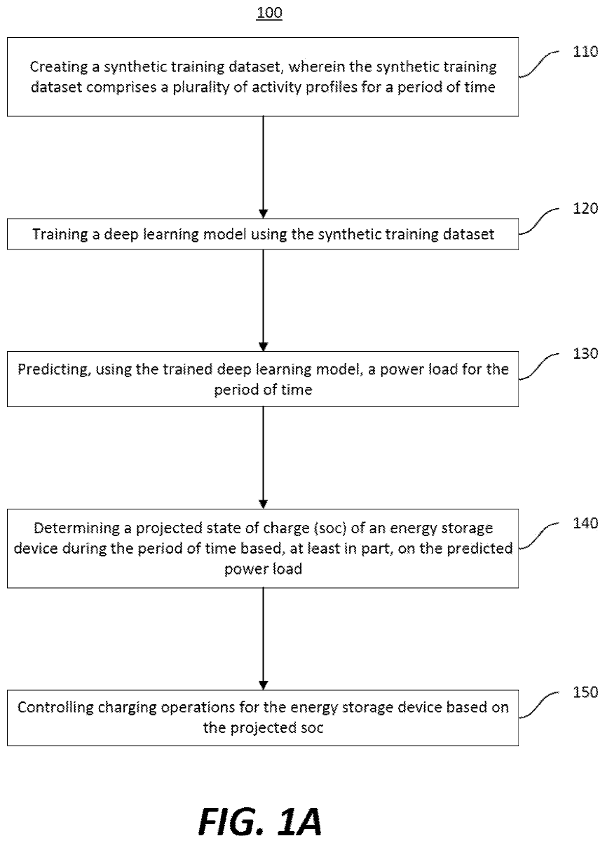

With reference to FIG. 1A, a method 100 of optimized energy management is shown according to an implementation of the present disclosure.

At step 110, the method 100 can include creating a synthetic training dataset. The synthetic training dataset can include a plurality of activity profiles for a period of time.

Optionally, the period of time is the hotel period for a long-haul driver of a vehicle. As used herein, the hotel period can be any length of time that cabin loads are being used in the vehicle without the vehicle being in transit.

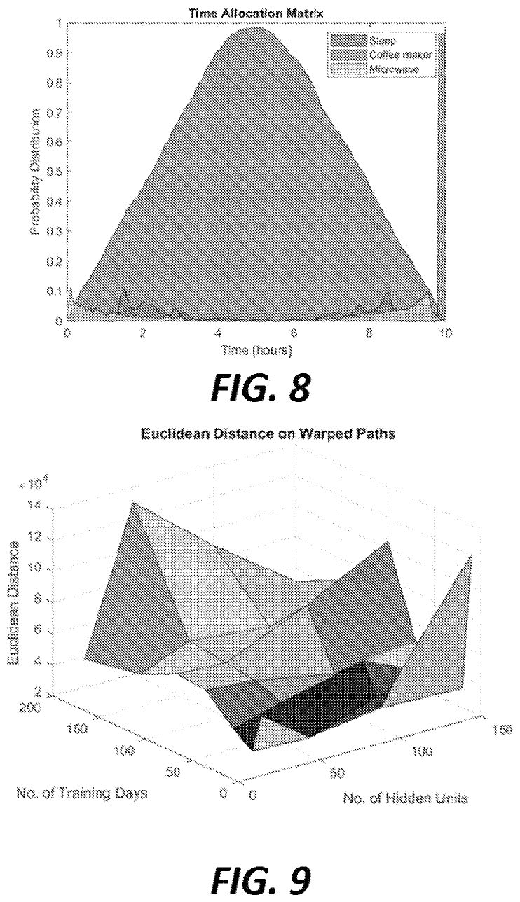

The synthetic dataset created at step 110 can optionally include a plurality of activity profiles from a base dataset. Activity profile creation is described in detail, for example, in Example 1 below. Alternatively or additionally, each of the plurality of activity profiles can include a time allocation matrix (TAM), where the TAM comprises temporal activity information. The temporal activity information can include probability density functions of activities over time. An example time allocation matrix is shown in FIG. 8.

Optionally, the plurality of activity profiles can further include sleep activity data and energy usage data. Alternatively or additionally, each of the plurality of activity profiles can include a power load profile.

Alternatively or additionally, each of the plurality of activity profiles an optionally further include a transition matrix (TM), wherein the TM comprises relational activity information. Relational activity information can be the probability of a next activity in the sequence being completed. Optionally, relational activity information can be modeled using a Markov chain.

At step 120, the method 100 can include training a deep learning model using the synthetic training dataset. According to the present disclosure, the deep learning model is trained to “learn” a function that maps an input (also known as feature or features) to an output (also known as target or targets) during training with the synthetic training dataset. For example, the features may include, but are not limited to, energy usage information such as the TAM and/or TM and sleep activity data, and the target may be a power load profile. The deep learning model is trained with the synthetic training dataset to maximize or minimize an objective function. This disclosure contemplates training the deep learning model using techniques known in the art.

Optionally, the deep learning model includes an artificial neural network (ANN). An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan H, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. ANNs are known in the art and are therefore not described in further detail herein.

Optionally, the deep learning model can be a recurrent neural network (RNN). An RNN is a class of artificial neural network where connections between nodes can create a cycle, allowing output from some nodes to affect subsequent input to the same nodes. The RNN has internal memory and can be used to analyze sequential or time series data. A non-limiting example RNN architecture is a long short term memory (LTSM). LSTM models are designed to handle sequential data, such as time series data.

It should be understood that RNN and LSTM are provided only as example deep learning models. This disclosure contemplates that the deep learning model can be another type of deep learning model.

At step 130, the method 100 can include predicting, using the trained deep learning model, a power load for the period of time. At step 130, the deep learning model is operating in inference mode. The deep learning model has therefore been trained (i.e. at step 120) and is configured to make predictions based on new input data. Accordingly, such a model is referred to herein as the “trained deep learning model.” The input to the trained deep learning model can include measurements of energy usage and/or power consumption taken during a first time period (e.g., a first hotel period). Alternatively or additionally, the input to the trained deep learning model can include energy consumption during the start of the hotel period. Alternatively or additionally, the input to the trained deep learning model can include power consumption during any part of the hotel period. Additional non-limiting examples of the outputs of the trained deep learning model include the power load for an entire day, an entire hotel period, or a period of time within a day or hotel period (e.g., a certain number of minutes or hours). As yet another non-limiting example, input can be the power load during one or more time periods (e.g., hotel periods). The output can be the predicted power load for a future time period (e.g., the next hotel period).

At step 140, the method 100 can include determining a projected state of charge (SOC) of an energy storage device during the period of time based, at least in part, on the predicted power load. As a non-limiting example, the energy storage device can include one or more batteries or battery packs (e.g., packs of lithium or lead-acid batteries). Optionally, the batteries or battery packs can be part of an electric and/or hybrid power train for a vehicle (e.g., a truck). Optionally, the projected SOC can be based on both the predicted power load and a predicted HVAC load. An example HVAC model that can be used to predict the HVAC load is described in Example 2. In some implementations, dynamic programming can be used to obtain the projected SOC, and the dynamic programming inputs can include the predicted HVAC load and the predicted power load.

At step 150, the method 100 can include controlling charging operations for the energy storage device based on the projected SOC. Optionally, controlling charging operations for the energy storage device based on the projected SOC can include controlling a vehicle engine. Alternatively or additionally, controlling charging operations for the energy storage device based on the projected SOC can include controlling a vehicle engine. Non-limiting examples of controlling the engine can include starting the vehicle engine to charge the battery, and/or turning off the engine to stop charging the battery.

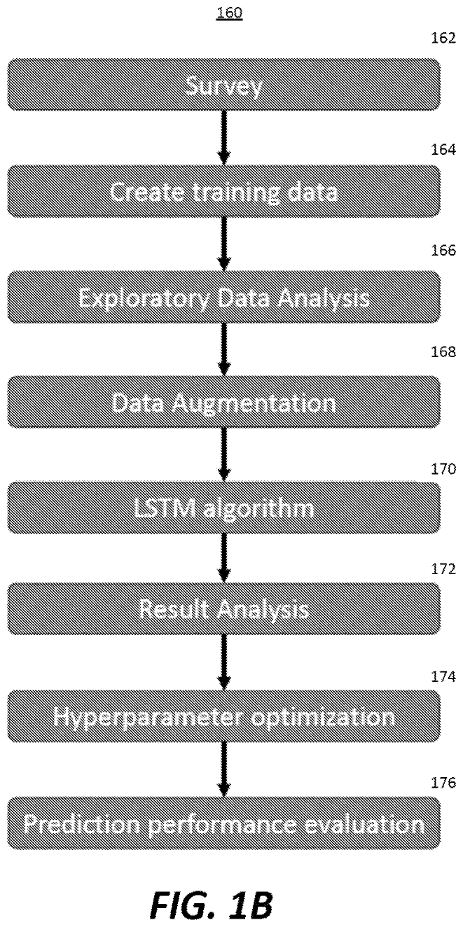

With reference to FIG. 2, implementations of the present disclosure include systems for optimized energy management. The system 200 shown in FIG. 2 can include an energy management controller 210 and a vehicle 250. The vehicle 250 can include an engine 260 and an energy storage device 270.

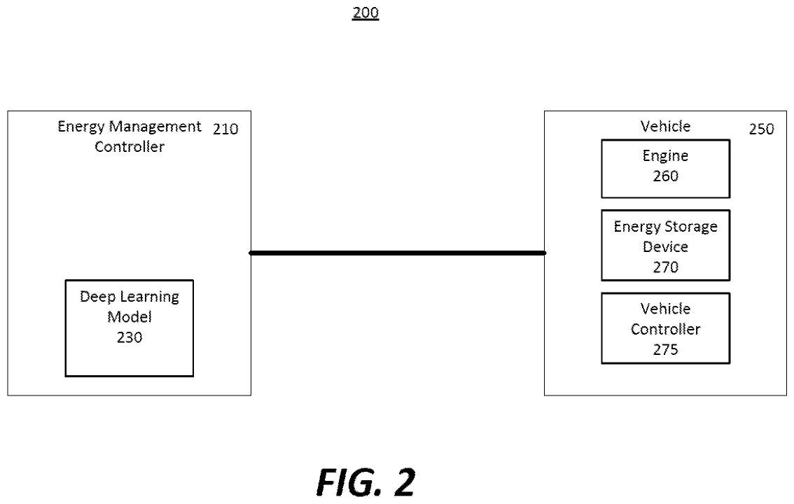

The energy management controller 210 can include a computing device (e.g., the computing device 300 shown in FIG. 3), including a processor and a memory. The energy management controller 210 can be operably coupled to the vehicle 250. In some implementations, the energy management controller 210 can be connected to the vehicle 250 by a network (e.g., the network connections 316 illustrated in FIG. 3). The energy management controller 210 can include a synthetic training dataset 220 and a deep learning model 230.

The energy management controller 210 can be configured to perform any one or more of the steps of the methods described with reference to FIGS. 1A-1B.

Optionally, the energy management controller 210 can be configured to create a synthetic training dataset, where the synthetic training dataset can include a plurality of activity profiles for a period of time. Optionally, the synthetic dataset can be created using a number of activity profiles from a base dataset. It should be understood that the energy management controller 210 can be configured to run a trained deep learning model, and that the deep learning model 230 can be a trained deep learning model.

In some implementations, each of the plurality of activity profiles comprises sleep activity data and energy usage data. Optionally, each of the plurality of activity profiles comprises a time allocation matrix (TAM), wherein the TAM comprises temporal activity information. Alternatively or additionally, each of the plurality of activity profiles can include a transition matrix (TM), where the TM can include relational activity information. Alternatively or additionally, each of the plurality of activity profiles comprises a power load profile.

The energy management controller 210 can also include a deep learning model 230. The deep learning model 230 can be trained using a synthetic training dataset as described with reference FIG. 1A-1B. Optionally, the deep learning model can include a recurrent neural network. Alternatively or additionally, the deep learning model can include a long short term memory (LTSM) model.

The energy management controller 210 can be configured to predict a power load for the vehicle 250 for a period of time. As a non-limiting example, the period of time can be a hotel period for a long-haul vehicle driver, but it should be understood that any length of time, including any length of hotel period, can be used.

Using the prediction, the energy management controller can determine a projected state of charge (SOC) of an energy storage device 270 during the period of time based, at least in part, on the predicted power load. The energy management controller 210 can control charging operations for the energy storage device 270 based on the predicted power load and the projected state of charge. Optionally, the engine 260 can be used to charge the energy storage device 270, and the engine 260 can be controlled by the energy management controller 210 based on the projected SOC (for example, to charge the energy storage device 270 to the projected state of charge). As a non-limiting example, the energy management controller 210 can turn the engine 260 on to charge the energy storage device 270 and turn the engine 260 off to stop charging the energy storage device 270. By turning the engine 260 on and off, the energy management controller 210 can control the SOC.

In some implementations, the energy management controller 210 can be located on the vehicle 250. As a non-limiting example, the energy management controller 210 can be part of any computing device located on the vehicle 250. In some implementations, the energy management controller 210 can be located separately from the vehicle 250 (e.g., on another computing device or server). When the energy management controller 210 is separate from the vehicle 250, the energy management controller 210 can operably coupled to the vehicle 250 by a communication link (e.g., a cellular network) such that the energy management controller 210 can communicate with the vehicle 250. Optionally, the vehicle 250 can include a vehicle controller 275 configured to receive instructions from the energy management controller 210 and/or transmit information about the power consumption of the vehicle 250 to the energy management controller 210. Optionally, the synthetic dataset step 110 of the method 100 shown in FIG. 1A can be performed on the energy management controller 210, which can reduce the amount of memory and processing power required by the vehicle.

In some implementations, the vehicle controller 275 can include a lightweight machine learning model. As used herein, the term “lightweight” model refers to models that can require fewer computational resources and/or less memory to run in inference mode. The lightweight machine learning model can be based on the deep learning model 230. The lightweight machine learning model can be a version of the deep learning model 230 that is optimized to efficiently operate in inference mode. The lightweight machine learning model of the vehicle can optionally be incrementally trained based on new data.

Alternatively or additionally, it should be understood that in some implementations, the deep learning model 230 trained by the energy management controller 210 can be used to generate lightweight machine learning models for any number of vehicles 250. Optionally, the vehicles 250 can update the respective lightweight machine learning models of each vehicle 250 based on the actual energy usage of each vehicle 250. This approach can allow for efficient training of the deep learning model 230 using synthetic data (e.g., according to the methods 100, 150 of FIG. 1A and FIG. 1B, described herein); as well as efficient deployment and customization of the deep learning model 230 for any number of vehicles using the lightweight machine learning models.

It should also be understood that performance optimizations can be used for the HVAC models described herein. The equations of example 2 can optionally be discretized and/or mapped for faster computation.

FIG. 1B illustrates a method 160 for modeling energy consumption, according to implementations of the present disclosure.

At step 162, the method 160 includes collecting information (e.g., survey information). For example, step 162 can include collecting information and drawing observations from surveys in literature about driver sleeping & driving behavior. Alternatively or additionally, the information can include compilation of driver schedules during hoteling and/or surveys from online available forums/videos/blogs from truck drivers.

At step 164, the method 160 can include creating training data. The training data can be created using the derived observations to create rules which can be used in duplicating the data into 1000's of data points for machine learning model training.

At step 166, the method 160 can include performing exploratory data analysis. Exploratory data analysis can include extracting additional information from the data using data analysis to produce additional features. Additional features can support machine learning model training.

At step 168, the method can include data augmentation. The data augmentation can be performed using the additional features created in step 166.

At step 170, the method can include using an LSTM algorithm based on the data augmented at step 168.

At step 172, the method can include result analysis. The result analysis can include analyzing and processing the output of the LSTM algorithm to establish a uniform comparison metric.

At step 174, the method can include hyperparameter optimization. Hyperparameter optimization can include tuning algorithm parameters to find an optimal compromise between the accuracy of the algorithms and the computational power required for the algorithms.

At step 176, the method can include prediction performance evaluation. Prediction performance evaluation can include checking algorithm accuracy for the predicted overall energy consumption.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

An example implementation of the present disclosure includes methods of predicting cabin load in long haul trucks. Predicting cabin load in long haul trucks can be important to operating trucks efficiently. For example, long haul trucks can include batteries that are charged from an engine or generator while the truck is operating, or from an electric charger (e.g., a charger connected to the electric grid). When the engine or generator is not running, the battery is responsible for providing energy to the truck, including the truck cabin. If the battery is over charged, it can result in wasted energy (for example, wasted fuel used to charge the battery). On the other hand, if the battery is under charged, the truck can run out of energy before the engine/generator is started again. Thus, it is desirable to accurately predict how much energy will be used when the engine/generator is not running, so that the batteries can be sufficiently charged, but not over charged.

Implementations of the present disclosure can be used for hybrid or electric trucks where energy management of the batteries can be especially important. Alternatively, implementations of the present disclosure can be used for conventional internal combustion trucks where idling the engine can be harmful.

Hybridization of the vehicle allows for the substitution of this idling (to power the auxiliaries) with any Energy Storage System (ESS) like battery packs. Moreover, it is important to ensure the battery pack has sufficient State-Of-Charge (SOC) at all times. This is not entirely possible because of the limitation in the battery sizing, hence there might be instances where some idling may be required to charge the battery back up. In this situation, it is helpful to know how much instantaneous power or the total electrical energy would be required in the hotel period so that the battery pack is only sufficiently charged and only charged at required times eliminating unnecessary idling.

The present disclosure includes methods to predict these electrical loads in the sleeper cabs of the trucks using machine learning methods. In the present example, a neural network referred to herein as Long and Short Term Memory (LSTMs) can be used to predict the power demand as a time series. LSTMs can be very capable of capturing temporal dependencies quite well and hence is the algorithm of choice. The algorithm is trained for 20 days and makes predictions for the 21st day. Data is in the form of on/off timing of each device in the 10-hour hoteling period. At each instant, the rated power of all the devices that are switched on is added together to form 1 time series capturing the total power. This can be fed into the LSTM network along with the temporal and relational information about the different devices. Because of limitations in finding data about driver behavior during hoteling periods in the industry, some survey information made available by the industry partner and some surveys reported in the literature about driver sleeping behavior were studied. This study is used to derive some observations about driver behavior and this information is replicated into 1000 synthetically generated datasets which were used to train and make predictions. After generating predictions, they can be validated visually and numerically.

For visual validation, dynamic time warping can be used to map the prediction to a test day and for numerical validation, the error in total energy consumption is used and the accuracy attained by the example implementation was 90%. Optionally, the dynamic time warping can “level the field” of running standard error comparison matrices. For example, dynamic time warping can allow for more accurate alignment and/or comparison of sequences of data. Dynamic time warping can be used in implementations of the present disclosure to handle temporal distortions or variations in speed or timing of sequences of data. Alternatively or additionally, dynamic time warping can be used for hyperparameter optimization.

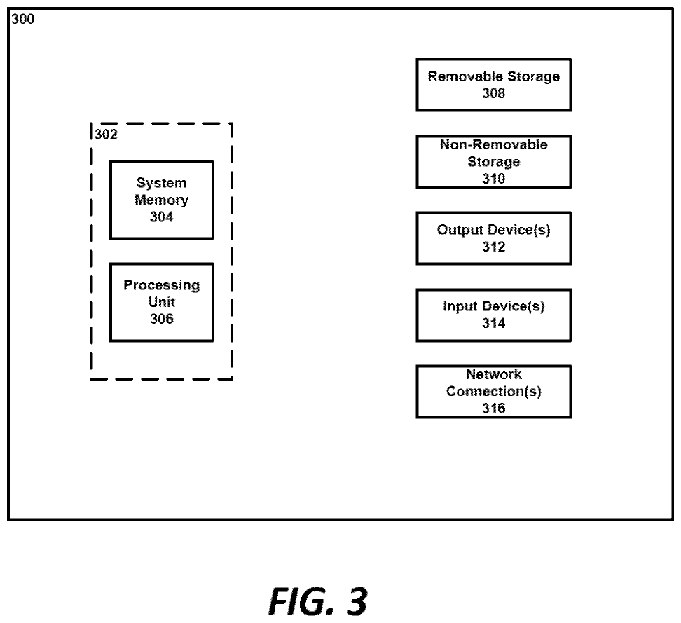

In some implementations, the types of power loads that are expected in the hotel period can be predicted. FIG. 4 illustrates examples of typical cabin electrical loads on a long-haul truck. These include the use of a lamp, TV, radio etc. Predicting these activities can be used to predict instantaneous power expected in the next time horizon (e.g., until the end of the hotel period). In a situation where the battery reaches the minimum allowable SOC, this prediction can be used to idle the vehicle to charge the battery just enough. In the example implementation of SuperTruck II, the HVAC is also powered by the battery pack hence also comes within the cabin loads. However, the HVAC power requirement estimation is not a part of the this predictive algorithm because of its dynamic nature. A physics-based model can be developed instead for the e-HVAC power load estimation modelled separately on MATLAB/Simulink [Khuntia et al. (2022)].

User activity prediction can include Sequence Prediction via Enhanced Episode Discovery (SPEED). SPEED can be superior to other prediction algorithms like Active LeZi (ALZ) algorithm with temporal rule, or Patterns of User Behavior System (PUBS). User activity prediction can include using the temporal pattern of humans for the prediction [Aztiria et al. (2012)]. For example, a modified-SPEED algorithm can achieve 96.8% accuracy. [Marufuzzaman et al. (2015)], the authors introduce This prediction algorithm is also adopted for the prediction of activities in smart homes for gird power-cost manipulation. As another example an application of a multi layer Long and Short Term Memory (LSTM) algorithm to predict the time and duration of activities in a 24 hour period can include a two layer LSTM algorithm with 50 hidden units each can give good predictions with a learning on a moving 75 day window. [Goutham (2020)].

Time series prediction can be done using Recurrent Neural Networks (RNN) as the ability of having a “memory” which makes them good for long sequence prediction tasks. The RNN can remember contextual information through the hidden layer activations that are passed from one step in time to another. Different variants of RNN have been useful when temporal dependency of the data are important [Graves (2013)]. A popular variant of RNN is the Long and Short Term Memory (LSTM). LSTMs work in an iterative fashion like RNNs with the addition of a gating mechanism. It can include three gates named as: (i) Forget gate (ii) Update gate and (iii) Output gate which regulate the flow of information from input to activation, activation to activation and activation to output. This makes LSTMs robust against outliers in the data and learn long term dependencies and patterns in the time series. Deeper version of neural network, that is multiple (aka stacked) LSTM layers can be used to improve the performance [Goutham et al. (2021)].

Implementations of the present disclosure include systems and methods that can be used to implement energy prediction in vehicles, for example long haul trucks and/or hybrid trucks. The study described herein includes a method to synthesize data from a single available data set generated from a survey conducted by PACCAR Inc. Using the synthesized data, Neural Networks can be used to predict the future power load estimate (e.g., implemented using MATLAB). Moreover, implementations of the present disclosure can include leveraging the properties of Markov chain and an adaptation of a transition matrix. The study shows that the systems and methods disclosed can be used to output a prediction for the overall power demand. This power estimate can be used in the estimation of the projected SOC for the duration of the hotel period, which in turn is used for the idle/Engine On-Off control strategies.

The present disclosure includes different metrics for evaluating the predictions of a time series. For the activity prediction as a classification problem, classifier based methods can be used. In this work, the problem is formulated as a regression problem. Alternatively or additionally, a point-wise numeric distance between the prediction and the original values can be used.

Some of these metrics are:

Root mean squared error (RMSE): provides an average error throughout the predicted time series in real units.

$$RMSE = \sqrt{\frac{\sum {( {\hat{y}}_{i} - {y}_{i}^{*} )}^{2}}{T}}$$

Normalized RMSE (NRMSE): a method that uses a normalized error over the total range of values of the test set. This is particularly useful in the case when the prediction of the time of the activity is not critical.

$$NRMSE = \frac{RSME}{max ( {y}_{i}^{*} ) - min ( {y}_{i}^{*} )}$$

Mean Absolute Percentage Error (MAPE): another metric to evaluate the predictions where the error is normalized over the actual value. This error is a percentage of the true value.

$$M A P E = \frac{\sum ( \frac{\vert {\hat{y}}_{i} - {y}_{i}^{*} \vert}{{y}_{i}^{*}}}{T}$$

Another non-limiting example is an Error Threshold Function (ETF). [Minor et al. (2015)]. In this method, the error function,

$$I ( {\hat{y}}_{i} , {y}_{i}^{*} ) = 1 if \vert {\hat{y}}_{i} - {y}_{i}^{*} \vert < v , v$$

being a non negative threshold, i.e., error in a particular prediction contributes to the total error only if it is significant enough.

$$E T F = \frac{\sum I ( {\hat{y}}_{i} , {y}_{i}^{*} )}{T}$$

The predicted time series can also be seen as a signal and the test data as another signal. Using Dynamic Time Warping (DTW), the example implementation can determine the similarity between the two signals. DTW warps the x-axis (in this case, time axis) between the two signals to match the best y axis values irrespective of the lengths of the two signals [Müller (2007)]. For two inputs Y₁∈ [symbol] ^{N} and Y₂∈ [symbol] ^{N} DTW computes a cost matrix J∈ [symbol] ^{(N+1)×(M+1)} such that,

$${J}_{i , j} = d ( {Y}_{1 , i} , {Y}_{2 , j} ) + min \{ \begin{matrix}{J}_{i - 1 , j - 1} \\ {J}_{i - 1 , j} \\ {J}_{i , j - 1}\end{matrix}$$

Where, d is the distance between the Y₁ and Y₂ at time steps i and j respectively. It can be defined in any method like euclidean, absolute or squared. This cost matrix ‘J’ is then used to trace back from J_{N,M} to J_{0,0} which gives the best mapping of y values for the two-time series.

In the study described in the present example, DTW was used as the performance metric. Optionally, the present disclosure is configured to predict loads happening in a broad time horizon rather than focusing on the exact time in which the load is happening. As a non-limiting example, it may be more important to predict the load caused by a microwave being used in a long-haul truck, than it is to predict the exact point in time when the microwave is used. Using DTW the study can warp the time axis such that the similarity between the power load predicted and the power load profile of any test day can be checked and they can be compared.

The data described herein regarding energy usage can be collected using on board data loggers or OBD scanners. Optionally, the data can be predicted using estimations based on known literature related to energy usage. LSTM can be a data hungry algorithm and hence there is a need to generate a lot of data sets in order to give enough input to the algorithm to learn from it. In the example study, 1000 day's of data is synthesized from the base data.

A survey was conducted on the various drivers about their usual activities in a 10 hour hotel period and data is recorded. An auxiliary power usage is then generated. FIG. 4 shows the activity profile for each device used in the cabin of long-haul truck.

It can be seen from FIG. 4 that Activity 5 and the Activity 2 are on throughout the 10 hours hotel period and the activity 12 (sleep) is also done for a significant period of time. The example driver used the microwave and coffee maker for very short intervals (before and once after sleeping). It was seen in the example that the load requirement for these two Activities are relatively higher than the rest.

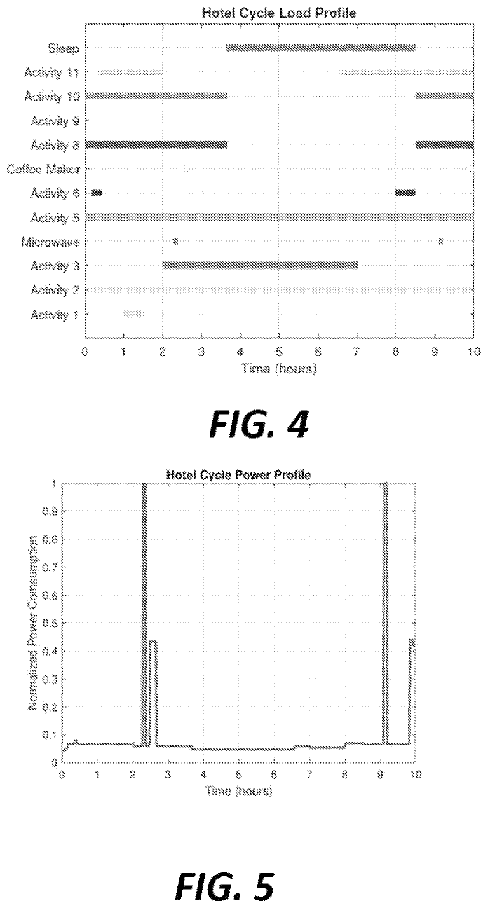

FIG. 5 illustrates the normalized electric power for the 10 hour hotel period. It can be seen that the load requirement increases to high values once in either half of the hotel period. This was likely because of the microwave and coffee maker.

Additional data sets were generated. First, the activities are divided into four groups, that are, i) sleep, ii) Food, iii) Coffee and iv) miscellaneous. As mentioned before, the miscellaneous activities do not have very high load contribution as compared to Food and coffee, hence individually do not influence the total power load profile unlike the usage of coffee maker and microwave which are rated relatively high. Hence the combined total load requirement from the miscellaneous activities is kept as same and is not varied throughout the 1000 different activity profile generated. Variability in the data is introduced using the food and coffee consumption and sleeping behavior and is discussed in the paragraphs below.

Sleep studies of 80 long-haul truck drivers with a total of 400 principal sleep periods have been conducted. [Mitler et al. (1997)]. Such studies have found that though the drivers desired an average ±SD sleep of 7.2±1.2 hours, in reality they may average 5.34 hours.

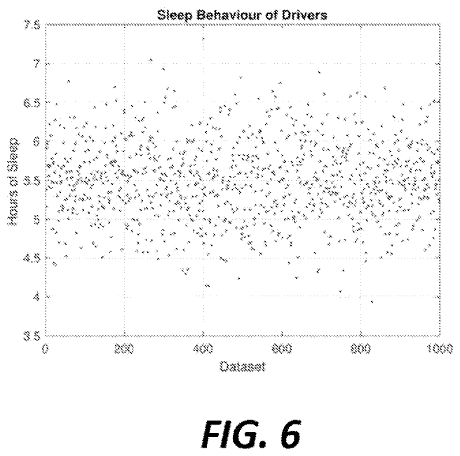

In the above study the average time off duty was less than 8 hours (7.4 hours), however in the example application, the number of OFF duty hours for the driver is 10 hours. In order to accommodate for the 2 hour increase, the sleep behavior of the driver is randomly generated using a Gaussian distribution X˜ [symbol] (μ, σ)˜ [symbol] (5.5,0.5), that is, 5.5 hours of average sleep with a standard deviation of 0.5 hours. FIG. 6 shows the random distribution of sleep hours for the 1000 days data set. It can be seen that the minimum can go up to 3.8 hours while the maximum can go up to 7.4 hours.

Usage of coffee makers can be variable between different drivers, and implementations of the present disclosure can be configured to consider variable usage patterns of coffee makers (and other devices). Optionally, it can be assumed that usage of coffee makers can be performed zero number of times to a maximum of one per hour of the awake time. Optionally, it can be further assumed that coffee is made in fixed intervals of 10 minutes each. It is assumed that the driver is very likely to make coffee in the last 10 minutes of the hotel period as well.

As another example, it can be assumed that the microwave is used twice during the hotel period. It can further be assumed that the microwave is used once at the start of the hotel period and again at the end of the hotel period. The total time for this activity is done is for a fixed interval of five minutes. It can also be assumed that the driver does not do this activity in the last 30 minutes of the hotel period just to account for the fact that they would be preparing for the journey and performing the last minute checks.

To avoid the redundancy in the synthesized data for training purpose, permutation and combination is used to calculate how many combinations of such activities are possible with the above discussed variability in the data. The total number of combination is equal to the number of possible unique data sets. For this calculation, the problem is conservatively simplified such that the sleeping activity can take 5 values between 4 to 8 hours. This introduces 5 different cases where different combinations of using microwave and coffee maker calculated. Adding up the number of combinations of these 5 cases, it is concluded that it is possible to generate 3.8e+10 unique data sets.

It should be understood that the different activities described herein, as well as the combinations of activities and assumptions are intended only as non-limiting examples, and that implementations of the present disclosure can include different activities, combinations of activities, and assumptions.

In the example implementation, the LSTM algorithm is set up as a regression problem with the input as a sequence and the output as the next value in the series (many-to-one) in a predictor response format where the response for a time step is added to the predictor and the combined becomes the predictor for the response of the next time step. Activity prediction can be a multi-variate problem, which can be converted to univariate by adding the load ratings of all the active devices at a particular time and predicting this total power load. This 1-D matrix would capture the information of multiple activities happening together and also would eliminate the need to create new categories in a classification problem. Time is discretized at 1 min to produce a 1-by-600 matrix containing the total power load profile for a 10 hours of hotel period. The input to the algorithm for training is a 25-by-599 matrix representing one day. Out of the 25 rows, 12 rows store the Time Allocation Matrix [TAM] as a 12-by-599 matrix, 12 rows store the Transition Matrix [TM] in a 12-by-599 matrix and 1 row stores the power load profile, P is a 1-by-599 matrix, hence it is fed to the algorithm as [TAM TM P]^{T}. The response is the power load at the next time step. For the prediction, the activities at the first minute of hotel period of the test day along with the relational information is provided as a 25-by-1 matrix and the algorithm predicts the power load. This value is appended to the power load prediction series and fed to the algorithm again to predict the power load value next in line until the end of the 10 hours.

The temporal information can be given in the form of a time allocation matrix which can store information about the probability distribution of each of the activities. FIG. 8 illustrates example probability distributions of three activities (sleep, Microwave, and Coffee maker). It can be seen that it is highly probable that the driver is sleeping at the middle of the hotel period. Since the mean of the sleep distribution is 5.5, hence, no matter when the driver starts to sleep, the chance of them being asleep at the 5\hat{ }“th” hour is very high. Also, the chances of microwave and coffee maker is high after sleeping. This behavior is also expected as the they used when the driver is not sleeping. Also, the probability of making coffee at the end of the hotel period is very high, this is because in the rule based data generation (discussed in example 1), very high weightage is given to the usage of coffee machine before the journey is resumed, i.e., end of the 10 hr hoteling period.

The transition matrix stores the relational information of the activities. It can predict the probability of the next activity in line [Gagniuc (2017)]. Using the Markov property, an n-by-n matrix for n-activities can be generated. In this n-by-n matrix, the element l-by m[l, m∈n] would store the probability of going from activity l to activity m at any instant. Hence, the rows of the transition matrix add up to 1.

The Markov property, however, is valid only when 1 activity is being performed at a given time instance. In the hotel period of long-haul truck, there can be multiple activities happening at the same time. This can be handled by setting breakpoints on the time stamps and calculate the conditional probability of all the activity next in line. The fundamental difference in this method is that the sum of probabilities of all the activities following a particular activity will be more than 1. Optionally, normalization can be used to force the sum of the rows to be equal to 1. In the example study, there are 12 activities, hence a 12-by-12 transition matrix was generated. As discussed herein, in transition matrix, the rows do not add up to 1. Such as the device corresponding to Activity 2 is switched “ON” for the 10 hours hotel period, the probability it will be switched on after a given activity is always 1. Moreover, the second column of the transition matrix is always 1.

To feed this information to the learning algorithm, the activities that are currently being done are recognized, and the transition probabilities from the activities are added together. For instance, if Activity 5, Activity 10 and Activity 11 are being done at time ‘t’, the rows of the transition matrix corresponding to these activities are added and this 12-by-1 matrix is transposed and appended to the input. Hence, for all 600 time steps, a 12-by-600 matrix represents the probabilities of the activities using relational information.

Optionally, implementations of the present disclosure can include the following steps:
(1) Split the data into training and test sets in a 9:1 ratio
(2) Create predictor

$${x}^{〈 1 : {T}_{x - 1} 〉}$$

and response

$${x}^{〈 2 : {T}_{x} 〉}$$

for the training sequences where Tₓ is the length of the series.
(3) Row wise append the predictor with TAM and TM, i.e., create the input matrix. and train the network.
(4) Use the trained network to predict the test day. An initial guess of x^{<1>} is 0 and a prediction y^{<1>} is made. This prediction is column wise appended to x^{<1>} as x^{<2>} and a prediction for 3 rd time step, i.e., y^{<2>} is made until y^{<Ty>}

The power load is normalized before being fed as input to the algorithm. This was observed to have improved the performance. The MATLAB neural network toolbox was used. The architecture of the LSTM is:
(1) Input Layer: With 25 features
(2) LSTM Layer: With 50 hidden units
(3) LSTM Layer: With 50 hidden units
(4) Fully Connected Layer: Multiplies the input weight matrix and adds the bias vector
(5) Regression Layer: Compares the mean squared error

It was seen that having a multi-layer LSTM worked better in capturing the minor trends in the data however having lot of LSTM layers increased the computation time exponentially. Two LSTM layers seemed to work perfectly well without compromise on the computation time. For training the algorithm, optionally the adam solver can be used with initial learning rate of 0.005 and gradient threshold of 1 for 250 epochs.

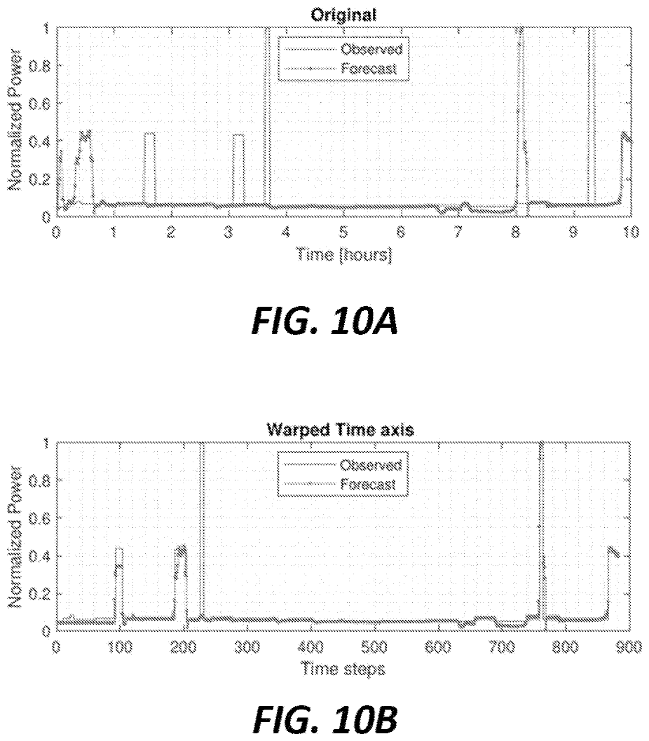

As discussed herein, DTW can be used to characterize the error. The number of hidden units and the period of training are chosen as the training parameters. The number of hidden units chosen are [20 50100150] while the training period is [10 204070100140 200]. With large number of hidden units the model is able to learn more relations between the events of the time series. While this is a desirable feature, it compromises on the computation speed and the risks over fitting. Similar is the case with the length of training set. FIG. 9 shows a surface plot of the error matrix, that is the euclidean distance measured point wise on the warped time axis, created using dynamic time warping of the test day power load profile and the predicted power load profile.

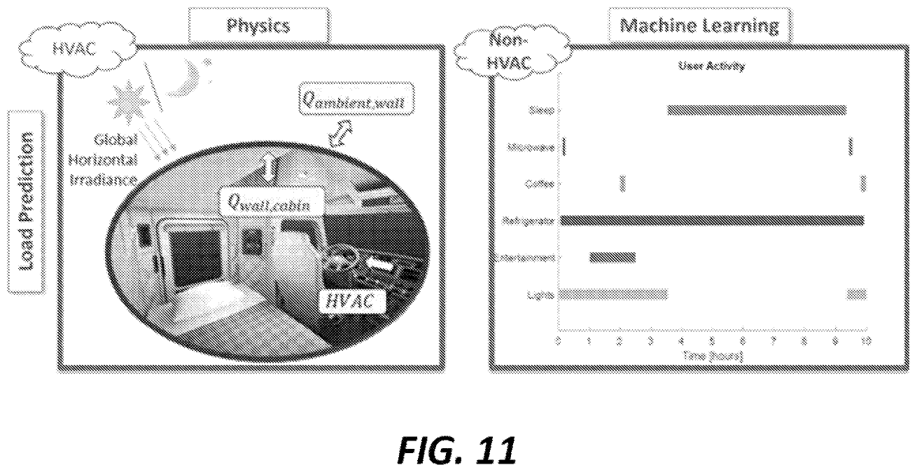

It was seen that increasing the number of hidden units or number of training days alone did not improve the accuracy. Having a small number of hidden units and training days did just as good of a job in the predicting the series as very high number of hidden units and training days. The global minimum error was found to be with 50 hidden units and a training period of 20 days. FIG. 10A shows the forecast and the prediction, while FIG. 10B shows the warped version of FIG. 10A. The warped version is a manipulation of the time axis such that DTW algorithm finds the minimum Euclidean distance between the two signals. Though in some cases warping the time axis can be undesirable to check the accuracy of a prediction, however in this case however it is an acceptable metric. This is because it can be more important for the algorithm to predict an event (in this case the total power load value) and in more general sense the pattern, rather than the exact time it is supposed to happen. In other words, it can be important for the supervisory control on the truck's ECU to know if there is going to be a surge in the power demand and prepare the battery for it.

The present disclosure includes a multivariate time series prediction problem is discussed and reduced to a univariate prediction problem. A combined effect of all activities as the total power load is predicted at a given time instead if predicting the individual power load ratings of the various devices inside the cabin of a long-haul truck. This algorithm is trained on synthetic data generated using observations and judgements from a baseline profile created from survey data. A multi-layer LSTM with each layer with 50 hidden units is trained on total of 20 days. The total time required for this training is about 4 minutes on a 32 GB RAM, 2.2 Ghz clock rate and 64-bit processor. Preference can given to predicting an event (an event being a particular load value) over the exact time of the event happening.

### Example 2

Implementations of the present disclosure include systems and methods that can be used to model and predict the performance of vehicles, for example long haul trucks. A study was performed using an example implementation of the present disclosure.

Optionally, the example implementation can include: a control-oriented two-node and three-node cabin model to estimate the cabin average air temperature at 93% accuracy for a heavy-duty truck.

Alternatively or additionally, the example implementation can include a vapor compression model including heat exchanger models (using moving interface method) with 95% accuracy and compressor model (using empirical relations) for power estimation for the compressor work with an accuracy of 98.4% in the HVAC system of a heavy-duty truck.

Alternatively or additionally, the example implementation includes a machine learning-based model to estimate the load from the driver behavior during the hotel period of a heavy-duty truck.

Alternatively or additionally, the example implementation can establish an optimal state of charge trajectory for a custom full-day route for a long haul application to reduce/eliminate the idling during hoteling saving up to $40 per day in fuel cost to the owner-operators.

The study described herein shows a control-oriented eHVAC and cabin models that can validated using the experimental data to measure their efficacy in a heavy-duty truck.

In some jurisdictions, long-haul truck drivers are mandated to take off-duty time of 10 hours (referred to herein as “hoteling”) before driving. Maximum driving time is 11 hours after 10 consecutive hours off duty. Driving is not allowed after being on duty for 14 hours. During the hotel phase, drivers spend time inside their trucks and idle the internal combustion engine for comfort by utilizing the heating ventilation, air-conditioning (HVAC), and other onboard appliances. A 13 L engine on average consumes about 0.8 gal/hour of diesel for idling while the auxiliary power unit consumes 0.5 gal/hour. For one 10-hour period, the average cost is about $40, which can be significant spread across the approximately one-million truck drivers idling overnight. An example truck, Super Truck II, is a 48 V mild-hybrid heavy-duty truck with auxiliary loads powered by an onboard battery pack.

An optimal control algorithm is described herein to charge the battery pack during the drive phase up to a certain state-of-charge (SOC) level, sufficient to meet the power demands of the auxiliary load during the hotel phase. The study described herein includes systems and methods to predict the energy consumption in a mild-hybrid heavy-duty sleeper truck during the hotel period. Physics-based grey-box models are developed to estimate the e-HVAC power consumption. E-HVAC refers to an electronically controlled compressor as compared to the conventional engine-run compressor. For the other auxiliary loads, a machine learning algorithm was developed to predict the power as a time series by tracking the user activity. The developed physics-based and data-driven models are validated for the experimental data of class 8 heavy-duty truck to show their efficacy. These implementations of the present disclosure also generate precise load profiles which are fed to the developed dynamic programming (DP) framework to generate the optimal SOC trajectories. These models ultimately help the vehicle's battery pack charge only up to the SOC necessary for the hotel phase during the drive time. When the vehicle is out of charge during the hotel phase, these models also help in estimating the amount of idling required to charge the battery enough to support the rest of the hotel period. This saves unnecessary idling. As a result a cost savings of $40 and CO₂ reduction of 175 lb to the environment is achieved for a single heavy-duty truck.

For the past 20 years, trucks have been a prime mode of freight transportation which has grown from nearly 25% of the total ton-mile in the US freight industry in 1980 to nearly 50% in 2020 (Margreta et al. (2014)).

Vehicles weighing over 33,000 pounds are classified as class 8 vehicles and semi-trailers come under this category. These class 8 vehicles are nearly 2.5% of the total commercial vehicles.

Nearly 2.5 million trucks travel long distances of 66,000 miles per year [Davis and Boundy (2021)]. According to the DOE SuperTruck report, class 8 tractor-trailers consume about 22% of the total transportation energy, which is nearly 28 billion gallons of fuel per year [Delgado and Lutsey (2014)]. Nearly 8% of this total fuel cost comes from the overnight idling of trucks for hoteling.

For the long haul journeys (journeys more than 650 miles per trip), Federal Motor Carrier Safety Administration (FMCSA), a federal agency with a mission to reduce commercial motor vehicle-related fatalities and injuries, mandates that drivers rest for 10 hours in every 14 hour of on-duty time [fmc (2022)]. These 10 hours in a 24 hour period are called hoteling. Nearly 1 million drivers practice hoteling overnight [ANL (2012)]. Studies from ANL also suggest that the drivers are idling for an average of 6 hours a day [ANL (2012)] [Gains (2017)]. Studies in California, on average a truck, is idled for nearly 30 hours in a week [Brodrick et al. (2001)].

Studies in National Renewable Energy Lab (NREL) in Stodolsky et al. (2000) show that class 8 sleeper trucks idle for nearly 1,800 hours in a year and consume nearly 838 million gallons of diesel fuel.

In efforts for electrification the usage of Auxiliary Power Units (APU) for auxiliary load is a well-established area for freight efficiency improvement. Kshirsagar (2015) demonstrated 50% energy consumption reduction in a fuel cell-powered APU as compared to a diesel engine. Surampudi et al. (2005) used 2.4 kW APU to power the 42 V accessories and found a reduction in energy consumption from 407MJ to 78MJ for the water pump and from 400 MJ to 176.1 MJ for air conditioning (AC) system respectively [Surampudi et al. (2004)] [Surampudi et al. (2005)]. Similar methods were used in Redfield et al. (2006) and even better improvements were reported with a fuel cell APU.

Controls also have played an important part in efficiency improvements. Using optimal control Surampudi et al. (2006) explored three control strategies for the Heating Ventilation and Air Conditioning (HVAC) system; (1) evaporator temperature control, (2) evaporator pressure control, and (3) cabin temperature control. For a 9000 second simulation, they observed an energy consumption of 932 kJ, 1228 kJ, and 975 kJ. They concluded that with electrified auxiliaries and a control strategy in place, the worst-case scenario would be nearly 1.3 kW of average power. Similar trends were observed in an electrified bus powertrain. Campbell et al. (2012) running a hybrid electric city bus for 145 hours in 11 days, an average power from ACOFF and ACON can be 11 kW and 19.3 kW. If the mechanical components are replaced with electrical components, there is a reduction in energy consumption reflected in 34% and 31% for AC OFF and AC ON respectively in fuel consumption benefit.

SuperTruck II is a parallel hybrid truck with an electric motor and a battery pack only big enough to support the engine off hoteling and parking lot maneuvers. While the hybrid drive doesn't support the torque split while driving, it is big enough to support all the auxiliary loads when the driver is resting inside the sleeper cabins of their trucks for 10 hours. If the battery runs out of energy during hoteling, the engine can be idled to charge the battery back up via the electric motor.

While there have been studies in model development for HVAC systems, there is not a complete detailed model coupled with a cabin temperature estimator. The models in the literature are single-node models for the HVAC load at the cabin which do not give the ability to develop low-level controls for the HVAC system. Apart from that there is no model currently predicting the driver's behavior during the hotel period and thereby no model exists to estimate the corresponding load.

The present disclosure includes advancements in the field of electrification of heavy-duty vehicles and its impact on the auxiliary loads. The present disclosure also includes mathematical modeling for the HVAC system driver behavior. The present disclosure further includes a simple control strategy to simulate the HVAC load for a 10-hour hotel period to estimate the instantaneous power. The present disclosure further includes one full day of on-duty/off-duty simulation for a driver doing a long-haul trip.

Hotel loads are the electrical loads that are seen on the battery pack during the 10 hours of hotel phase of a long haul truck. Although HVAC can contribute to nearly 30% of the total load during the drive time, it can go up to nearly 80% when the vehicle is in the hotel phase. This is because since the engine is turned off, all powertrain cooling components are also turned off. HVAC becomes a major contributor to this load and hence predicting it can help the supervisory controller to prepare for the load ahead of time.

For one day of travel on a long-haul transit. The driver is allowed 14 hours of on-duty time in which he/she takes two 30 minutes of rest and after the on-duty time, takes 10 hours of rest. To save fuel by eliminating idling, the battery pack needs to support the hotel loads. For this, the battery should be (1) big enough to take the highest possible load, and (2) charged only enough to support the load when it is not expected to be the highest. Regeneration from braking is not always sufficient to charge the battery during the 14 hour on-duty driving period, hence the engine needs to kick in at times. This can be leveraged to operate the engine at optimal operating points to maximize the engine and electric motor/generator efficiency. An optimal control algorithm developed in Singh et al. (2022) provides an optimal state of charge trajectory for a defined time horizon.

The challenge for deploying said algorithm is to pre-define all the inputs in the time horizon which includes the auxiliary load expected during the hotel period. Eliminating the engine idling can ultimately result in savings of nearly $40 per hotel period assuming 10 hours of hotel phase in a class 8 sleeper cab with a 13 L diesel engine at $5/gal cost of diesel fuel and saving nearly 175 lbs of CO₂ from being released into the atmosphere from a single truck per day. This saving will be significant when the fleet of heavy-duty vehicles is being considered.

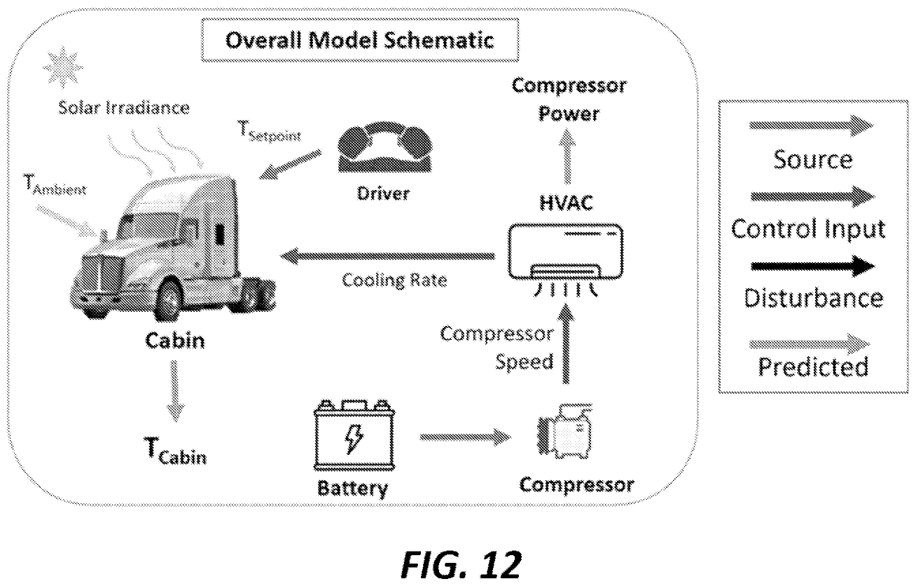

Optionally, the present disclosure can include energy modeling. Khuntia et al. (2022a) and Khuntia et al. (2022b). The energy estimated can be provided as an input to the optimal control algorithm which enables the battery to be charged to the SOC required at the battery pack before the hotel period starts while the vehicle is in motion. FIG. 11 presents an overall modeling approach, according to an implementation of the present disclosure. Optionally, the present disclosure includes a physics-based modeling approach for the modeling of HVAC components like heat exchangers, i.e., the condenser and the evaporator, compressor, and cabin of a sleeper cab, and using it in tandem with a machine learning model that predicts the loads from the activities of a driver when the vehicle is in hotel phase. When the load required exceeds the battery capacity, the optimal control also provides the instance the engine should idle to charge the battery and by how much.

Hotel loads are electrical loads that are seen on the onboard battery pack (e.g., during the 10 hours of hotel period of a long haul truck). Although HVAC can contribute to nearly 30% of the total load during the drive time, it can go up to nearly 80% when the vehicle is in a hotel period. This is because since the engine is turned off, all powertrain cooling components are also turned off. HVAC becomes a major contributor to this load and hence predicting it can help the supervisory controller to prepare for the load demands ahead of time.

As used herein, the following terms are defined:
αᵢ Heat transfer coefficient between tube wall and refrigerant per unit area [W/m²/K]
λ Friction Coefficient;
ρ Density of the refrigerant [kg/m³]
Dᵢ Inner diameter of the tube [m]
h Specific enthalpy [J/kg]
P Pressure in HX[pa]
Tᵣ Bulk temperature of refrigerant [K]
T_{w} Temperature of tube wall [K]
u Velocity of the refrigerant flowing along the tubes [m/s]

As used herein, additional terms were defined for the cabin model:
A Surface area for heat transfer [m²]
Cₚ Heat capacity at constant pressure [J/K]
m Mass [kg] Q Heat transfer [W]
T Temperature [K]
As used herein, additional terms were defined for modeling fluid dynamics:
\dot{m} Mass flow rate [kg/s]
v kinematic viscosity [m²/s]
h Convective heat transfer coefficient [W/m²/K]
k Thermal conductivity [W/K]
Nu Nusselt number
Pr Prandtle number
Re Reynolds number
v Flow speed [m/s]
W Surface width [m]
Cabin model equations
GHI Global Horizontal Irradiance [W/m²]
h Convective heat transfer [J/kg]

As used herein, additional terms were defined for modeling fans:
Φₘ Flow rate coefficient
N Engine Speed [rpm]
n Number of Fans
rₘ Mean fan radius

$$[ m ] = \sqrt{\frac{1}{2} ( {r}_{t}^{2} + {r}_{h}^{2} )} , {r}_{t}$$

is the fan tip radius, rₕ is the hub radius.
v′ Hub ratio, =rₕ/rₜ

As used herein, additional terms were defined for heat exchanger modeling:
(*)_{c} Property at the condenser; (*)_{c} Property in the hot side; (*)_{c} Property of cabin air (*)ₑ Property at the evaporator; (*)_{g} property at saturated vapour line; (*)ₕ Property in the hot side (*)ₗ Property at saturated liquid line; (*)ₘ Properties averaged through HX; (*)ₛ property of the surface; (*)ᵥ Volumetric property; (*)_{act} Actual property; (*)ₐᵢᵣ Property of air; (*)_{amb} Property of ambient; (*)_{fin} Property of the fin; (*)ᵢₛₑₙ Isentropic property; (*)_{ref} Property of the refrigerant; (*)_{win} Property of the window; a Heat transfer coefficient [W/m² K]; γ̅ Void fraction; \dot{Q} Heat transfer in/out of refrigerant from cross-flowing fluid [W]; \dot{V}_{disp} Volumetric displacement [m³]; ϵ Heat transfer effectiveness; η Efficiency cp specific heat capacity at constant pressure [J/kg/K]; F Air-Structure surface area ratio h Specific enthalpy [kg/m³]; n Polytropic constant; NTU Number of transfer units; U Overall heat transfer coefficient [W/m² K]; V Volume of heat exchanger [m³]; v Specific volume [m³/kg];X Vapor quality; x Vapor quality.

Additionally, as used herein, the following abbreviations are defined: 21CTP (21st Century Truck Partnership); AC (Air Conditioning); APU (Auxiliary Power Unit); CFD (Computation Fluid Dynamics); DOE (Department Of Energy); DTW (Dynamic Time Warping); EXV (Electronic Expansion Valve); FMCSA (Federal Motor Carrier Safety Carrier); HVAC (Heating Ventilation and Air Conditioning); HX (Heat Exchanger); LSTM (Long and Short term memory) and MHDV (Medium Heavy Duty Vehicle).

Additionally, the following terms will be understood by those of skill in the art: NN Neural Network; ODE Ordinary Differential Equation; PDE Partial Differential Equation; ph Pressure Enthalpy; R&D Research and Development; RAM Random Access Memory; RMSE Root Mean Squared Error; RNN Recurrent Neural Network; RPM Revolutions Per Minute; SOC State of Charge; TAM Time Allocation Matrix; TM Transition Matrix; TRL Technology Readiness Level; and US United States.

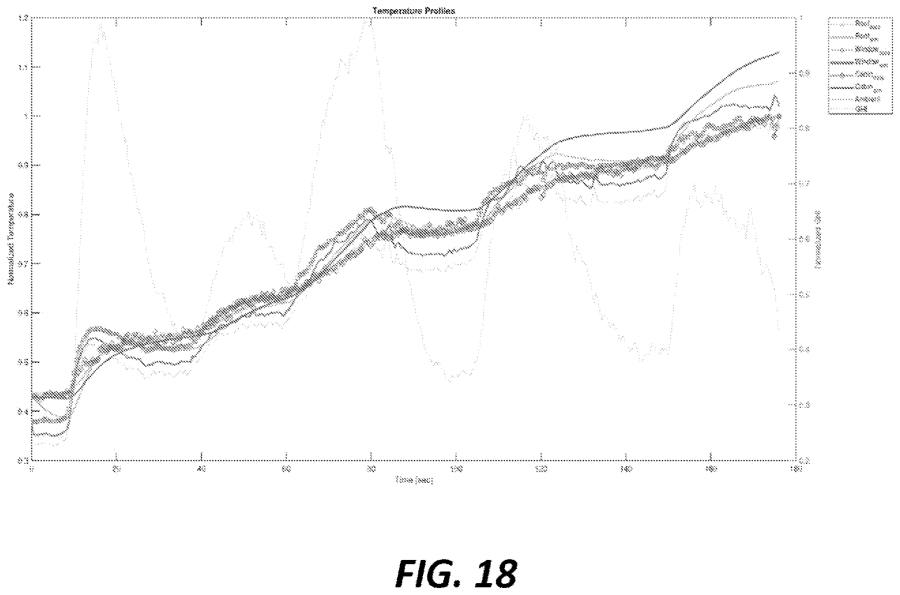

In the HVAC system, there are two HXs, a condenser on the ambient side, and an evaporator interacting with the control volume of interest (FIG. 19). For an AC application, a high-temperature refrigerant enters the condenser as a vapor. It enters a two-phase region and exits the condenser as a sub-cooled liquid. This sub-cool liquid is then depressurized using an expansion valve before it enters the evaporator. This depressurization helps the refrigerant to absorb higher heat content at the evaporator. The refrigerant then goes into the compressor where a mass flow rate is is controlled by adjusting the compressor speed.

Implementations of the present disclosure can include a cabin model. A vapor compression cycle system interacts with the cabin's internal air to cool or heat it up based on its application as AC or heat pump. It hence becomes important to predict the temperature of the cabin. In this work, a grey-box modeling approach is adopted to develop a model that can work for different cabins (by considering their size) by being calibrated against a universal test procedure. A literature survey helps to identify the right level of complexity to balance the accuracy of the temperature prediction and the complexity of the model.

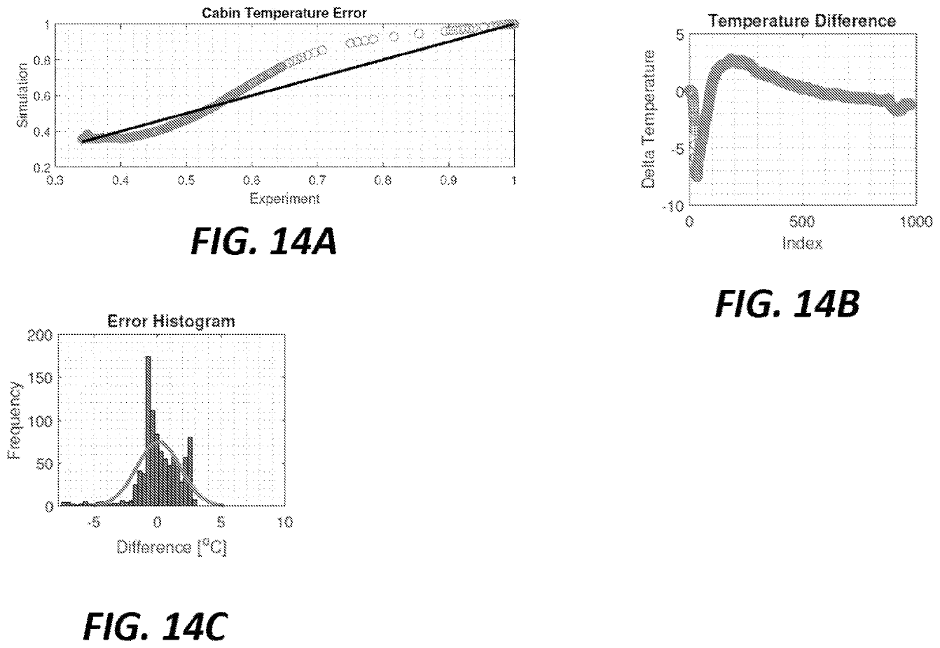

For developing the cabin model, the quantities of interest are the average temperatures of the roof and the windows, the HVAC air temperature from the interior vents of the cabin, and the temperature of the cabin's internal air with those are shown in FIG. 13.

This grey box model formulation takes inspiration from the heat transfer equations and is calibrated using the data. The objective of the model is to predict the cabin average air temperature using readily available weather data, i.e., the solar GHI [W/m²], ambient temperature [ ° C.], and additional wind/vehicle speeds.

The elements chosen in this heat transfer prediction are cabin air, windows, walls, and HVAC. While there are multiple sources of external heat to influence the inside cabin temperature, describing all can be cumbersome, increasing the complexity of the model, but also hard to calibrate using data from standard test procedures, and at the same time add little benefit to the prediction accuracy.

Implementations of the present disclosure can include a two-node model. In a class 8 truck cabin, the windows take up the majority of the area. A two-node model is developed with cabin internal air as one element and the window as the other. The heat transfer coefficients and the specific heats have been chosen as calibration parameters. Some of these calibration parameters can be derived and simplified using empirical relationships to help guide the calibration process and also can be used to guess their initial values.

In this example model, the effect from the roof has been ignored. A study in Okaeme et al. (2021) suggests that insulating the cabin to reduce heat transfer from the walls would still have a massive impact. Hence a two-node model is proposed accounting for the temperature dynamics of the cabin's internal air and the temperature dynamics of the windows.

Concepts from fluid dynamics are used to capture the heat exchanged from the effect of wind. The Nusselt number gives a relationship between the heat transfer coefficient from the convection to that from conduction and is highlighted in Eqs. (1, 2, and 3).

$${h}_{air} = \frac{N {u}_{a i r} {k}_{air}}{{W}_{surface}} \qquad ( 1 )$$

$$N {u}_{a i r} = 0.664 {Re}_{air}^{1 / 2} {Pr}_{air}^{1 / 3} \qquad ( 2 )$$

$${Re}_{air} = \frac{{v}_{air} {W}_{surface}}{{ν}_{air}} \qquad ( 3 )$$

Using these relationships, the heat transfer coefficient for a surface with cross-flowing wind is found by lumping all the constants in ‘k’ as shown in Eq. (4) and Eq. (5). Another term h_{amb} is added that accounts for the natural heat transfer coefficient in the absence of the wind.

$${h}_{a i r} = k {v}_{a i r}^{1 / 2} \qquad ( 4 )$$

$$h = {h}_{a m b} + k {v}_{a i r}^{0.5} \qquad ( 5 )$$

The h_{amb} is the heat transfer when the vehicle is stationary. The final model captures the temperature dynamics of the window (abbreviated as ‘win’) and the cabin is shown in Eq (6). The term V_{wind} is the relative velocity of the wind and the vehicle. The direction of the wind is not considered in the example study. The temperature of the air from the vents for the HVAC system in the cab is used as T_{hvac}.

$${C}_{w i n} \frac{{dT}_{w i n}}{dt} = β ( GHI ) + {H}_{win , c} ( {T}_{c} - {T}_{w i n} ) + ( {H}_{w i n , a m b} + {k}_{w i n} {V}_{wind}^{1 / 2} ) ( {T}_{a m b} - {T}_{w i n} ) {C}_{c} \frac{d {T}_{c}}{dt} = {H}_{win , c} ( {T}_{w i n} - {T}_{c} ) + γ \dot{m} c {p}_{a i r} ( {T}_{h ν a c} - {T}_{c a b} ) \qquad ( 6 )$$

This two-node model has seven calibration parameters and the model is calibrated using a gradient-free optimization method reducing a custom cost function (which is the root mean squared error between the simulated and the experimental values). The objective function in this dynamic optimization problem has been defined as the weighted sum of the two nodes. To bias the prediction accuracy towards the primary quantity, that is, cabin temperature, different weights were tried. However, it was found that having an equal weight for all the parameters gave equal benefit in prediction as any other weighting combination. This is because while biasing the prediction to favor the cabin temperature, authors consequently ignore the other node. Because of the coupling in the model equations, having a bad prediction for the other node would ultimately impact the accuracy of the primary node too.

It was observed that Root Mean Squared Error (RMSE) values are within the allowable range and the window node is predicted as desired. Although, cabin air temperature shows a deviation of 4 degrees which is a high value. A positive error implies that the temperature of the cabin is predicted to be lower than the actual. This is suggesting that there is a source of heat in the cabin which is ignored. This is designated as the wall of the truck. Hence, a three-node model is proposed to capture the temperature of the roof and is described below.

This estimation is useful when the vehicle is stationary, i.e., during the hotel phase. However, the effects of wind or a moving vehicle on the temperature of the cabin are also vivid. Due to the disparity in the heat transfer coefficients between the walls and the windows, the vehicle while moving might not affect the heat of the cabin through walls, but it might affect the windows.

Although the window covers most of the heat convection to the cabin's internal air. Because of the solar GHI, the roof on a sunny day can get really hot. This might force the roof element to also have an impact on the temperature of the cabin. To study this effect a new node is added to the 2-node model for the roof of the truck and the updated model is presented in Eqs (7,8, and 9) and the improvements from a 2-node model are studied.

$${C}_{r o o f} \frac{{dT}_{roof}}{d t} = α ( GHI ) + {H}_{r o o f , c} ( {T}_{c} - {T}_{r o o f} ) + ( {H}_{roof , amb} + {k}_{r o o f} {V}_{w i n d}^{0.5} ) ( {T}_{a m b} - {T}_{w i n} ) \qquad ( 7 )$$

$${C}_{w i n} \frac{d {T}_{w i n}}{d t} = β ( GHI ) + {H}_{win , c} ( {T}_{c} - {T}_{w i n} ) + ( {H}_{w i n , a m b} + {k}_{w i n} {V}_{w i n d}^{0.5} ) ( {T}_{amb} - {T}_{w i n} ) \qquad ( 8 )$$

$${C}_{c} \frac{d {T}_{c}}{dt} = {H}_{w i n , c} ( {T}_{w i n} - {T}_{c} ) + {H}_{r o o f , c} ( {T}_{r o o f} - {T}_{c} ) + γ \dot{m} c {p}_{a i r} ( {T}_{h v a c} - {T}_{c a b} ) \qquad ( 9 )$$

The same data used is used to calibrate the 3-node model as the 2-node model with an added vector of the roof temperature. Each element is isolated to find the right parameters for the node as long as they can be independent of each other. Since the window and roof can be, the values found for H_{win,c} and H_{roof,c} in separate calibration and reused while calibrating for the parameters for the cabin node. For fine-tuning, after calibrating all the node parameters separately, a calibration was run again, with all parameters combined in a single calibration. A biased-based cost function was defined just like the cabin model with two nodes and similar results were observed.

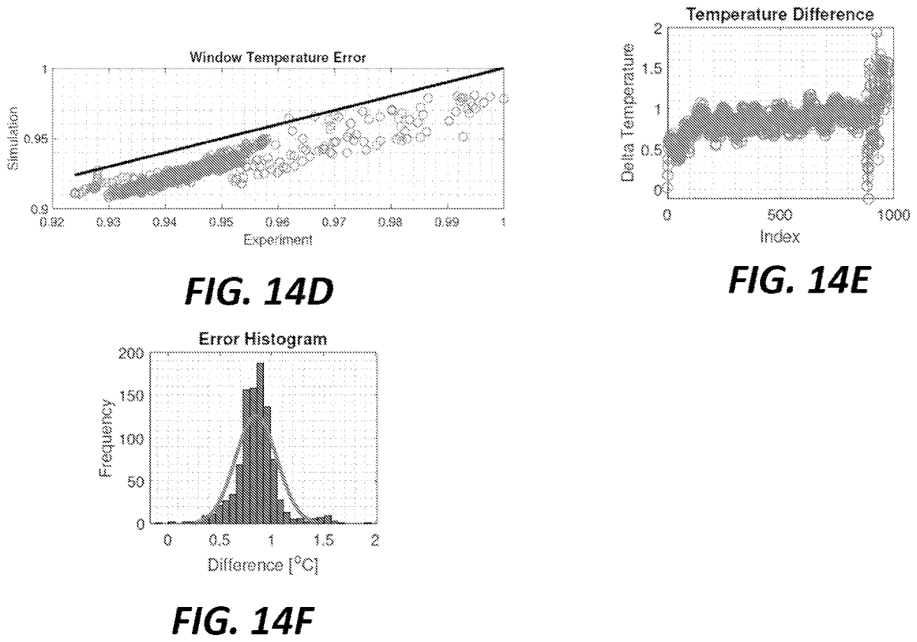

FIG. 14A illustrates example cabin temperature error for an example implementation of the present disclosure that was studied. FIG. 14B illustrates example temperature difference for an example implementation of the present disclosure. FIG. 14C illustrates an example error histogram for an example implementation of the present disclosure.

FIG. 14D illustrates example window temperature error for an implementation of the present disclosure that was studied. FIG. 14E illustrates example temperature difference for the example implementation of the present disclosure. FIG. 14F illustrates an example error histogram for an example implementation of the present disclosure.

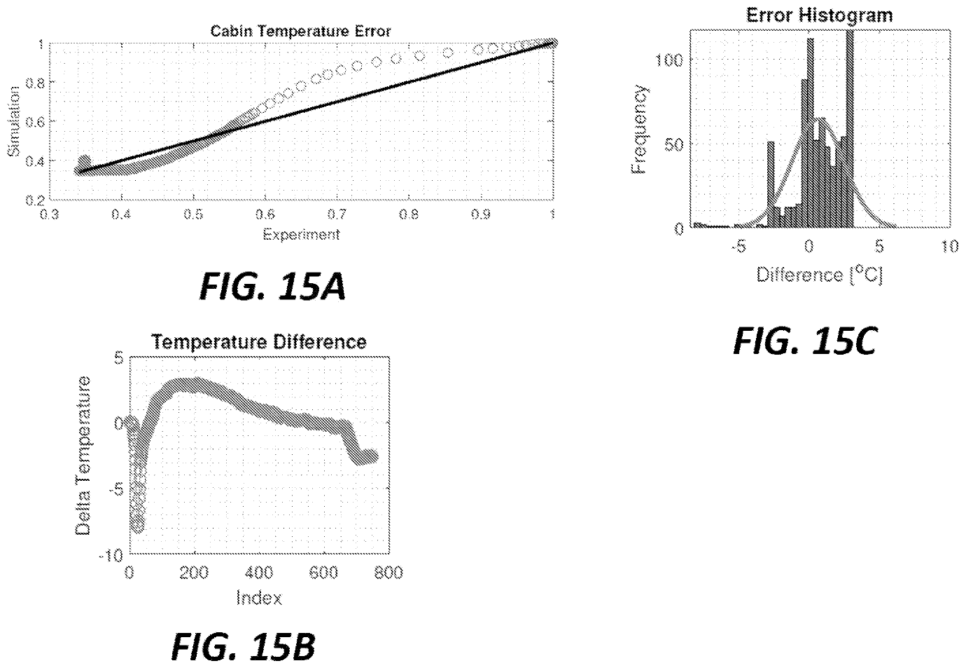

FIG. 15A illustrates example cabin temperature error for an example implementation of the present disclosure that was studied. FIG. 15B illustrates example temperature difference for an example implementation of the present disclosure. FIG. 15C illustrates an example error histogram for an example implementation of the present disclosure.

FIG. 15D illustrates example window temperature error for an implementation of the present disclosure that was studied. FIG. 15E illustrates example window temperature difference for the example implementation of the present disclosure.

FIG. 15F illustrates example roof temperature error for an implementation of the present disclosure. FIG. 15G illustrates example roof temperature difference for an implementation of the present disclosure. FIG. 15H illustrates an example error histogram for an implementation of the present disclosure.

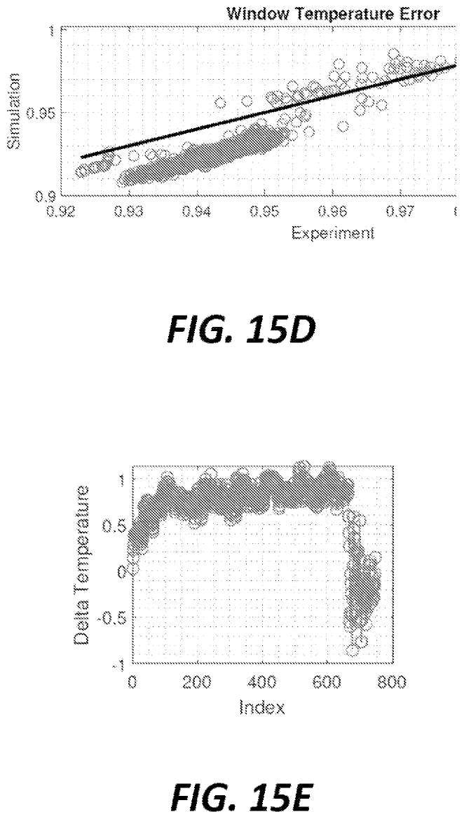

A comparison of the proposed models illustrated in FIGS. 14A-14F and FIGS. 15A-15H is given in FIG. 16. FIG. 16 illustrates RMSE comparison of 2-node model and 3-node model. It is observed that the 3-node model illustrated in FIGS. 15A-15H has RMSE of 0.3° C. as compared to the 2-node model illustrated FIG. 14A-14F while adding five additional calibration parameters in the model.

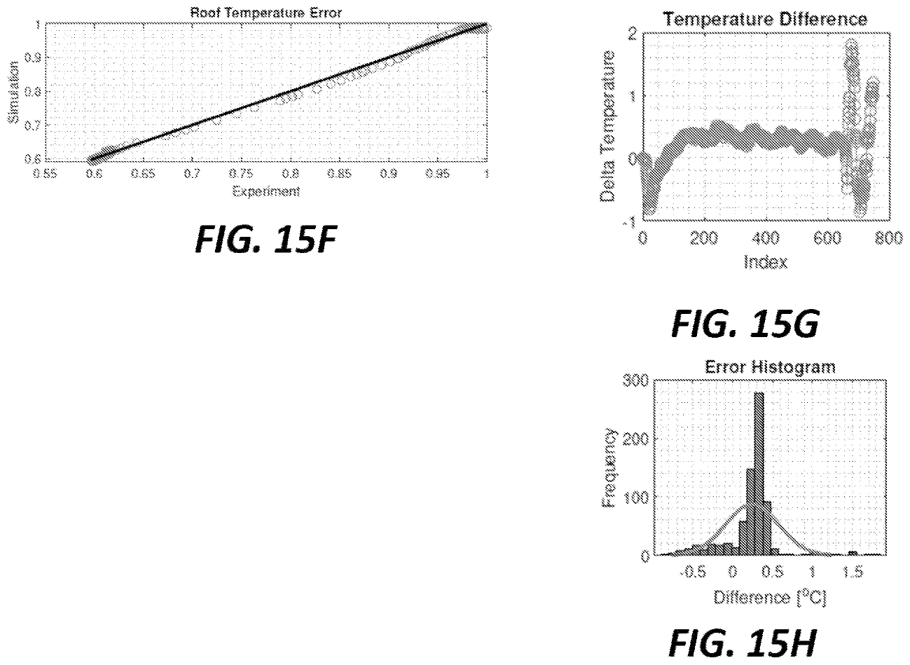

The study included model validation. To compare the above given 2-node and 3-node models, a different vehicle was used in the test cell. The idea behind this validation is to see which model holds more accuracy across different vehicles. Unlike the previous calibration, the model may not require the majority of the data set to calibrate the model parameters for this new vehicle since the parameters are already calibrated for a similar vehicle. Different sizes of data from the data set are chosen to study how quickly these two models can adapt. Three instances were evaluated where 10%, 30%, and 60% of the data for calibration, and the results are reported in FIG. 17.

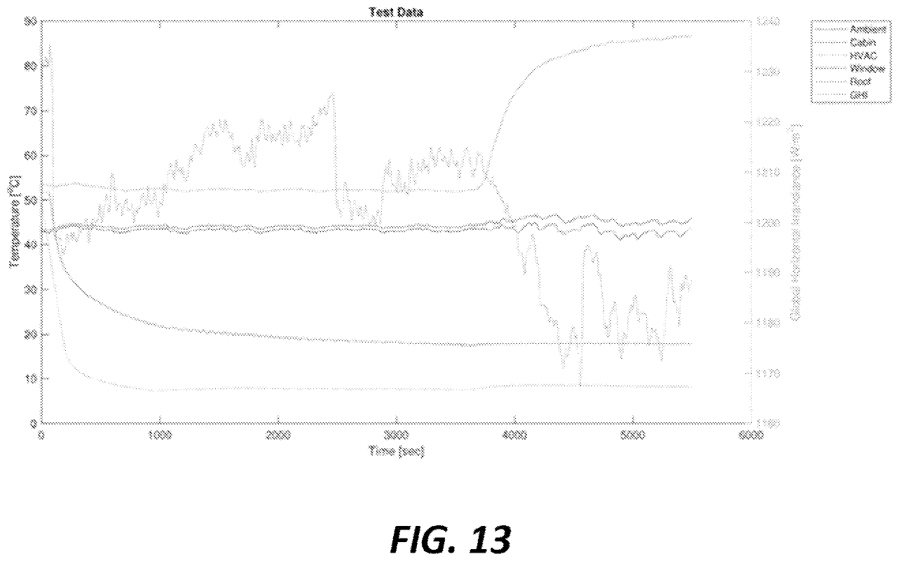

As the amount of data used for calibration is increased as expected the error reduces (FIG. 12). The temperature of the windows was consistently accurate through all the calibrations and both the models. There is a massive improvement in roof temperature tracking with increasing data. It can be seen that the error is within ±5° C. with the mean at nearly zero for all the nodes. The error at the cabin seems to be increasing with time. This is due to the lack of windshield temperature data. The windshield is directly impacted by the solar lamp (in the test cell) and hence the sun. Optionally, the side window temperature can be used instead. Since the side windows are not impacted as much by the heat of the sun as the windshield, they can represent a lower temperature. The cabin takes in heat directly from the windows too, a lower temperature from the windows indicated a lower temperature for the cabin. Hence, adding the window temperature would fix the increasing cabin temperature error.

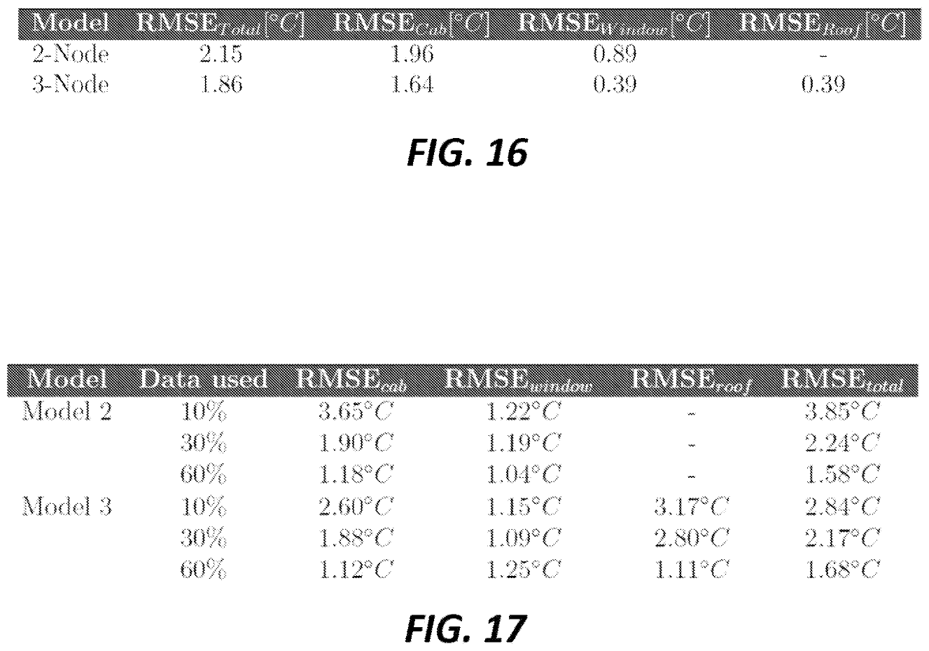

When 60% data is used in calibration, both the 2-node model and 3-node model perform about the same for the cabin temperature estimation. However, when the data is reduced to 10% the 3-node model performs better. This implies that the 3-node model, a smaller data set for a given vehicle will be required to obtain the same accuracy as the 2-node model with larger data. The number of calibration parameters, in this case, seems to have a smaller effect than previously assumed. FIG. 18 shows the final prediction of the cabin temperature, window temperature, and roof temperatures from the model using the new data set.

Implementations of the present disclosure can include a vapor compression cycle model. Air conditioners and heat pumps can work on a principle described by the vapor compression refrigeration cycle or vapor compression cycle as shown in FIG. 19. In this method, cooling/heating is achieved by exchanging the heat of a system with the environment via a refrigerant. Most vehicles and households use a refrigerant called R134a and it is used in this application as well.

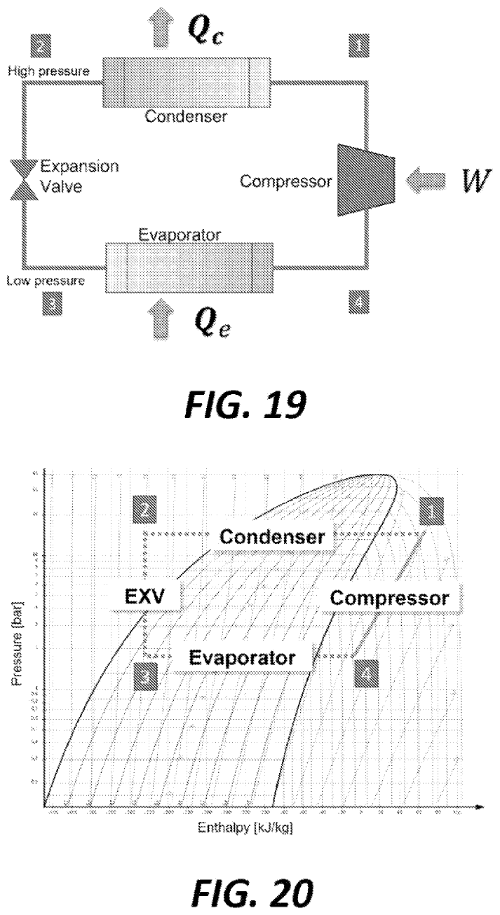

FIG. 19 shows the components in a vapor compression cycle and FIG. 20 shows its equivalent on a pressure-enthalpy (ph) diagram. The area between the two solid lines is the two-phase region. For an AC application, the evaporator module interacts with the space that needs to be temperature controlled. The refrigerant enters the evaporator at point 3 as low-pressure and low-temperature two-phase fluid where it absorbs the heat to exit as a superheated gas—point 4—from the relatively hotter cross-flowing air through the evaporator. The hot refrigerant then reaches the condenser at a higher pressure and temperature as a superheated gas (point 1) and a relatively cooler cross-flowing fluid absorbs this heat changing the refrigerant to a two-phase fluid and ultimately to sub cool liquid as the refrigerant cools down.

The Electric Expansion Valve (EXV) at the exit of the condenser is used to decrease the pressure of the refrigerant to lower its boiling point for effective heat transfer and achieved this effect at a constant enthalpy. The pressure difference achieved by the compressor pushes the refrigerant to a higher pressure by commanding a flow rate. This is represented by the green line. The work done to achieve this delta pressure is our point of focus. Compressor work is a function of the pressure ratio (P_{c}/Pₑ) and compressor speed. A model is hence required that can represent the pressure of the refrigerant at the condenser and the evaporator and this is done by the HX model.

Large-scale Computational Fluid Dynamics (CFD) tools have been useful in modeling the complicated state transitions in fluids in small control volume flows also shown in Altwieb et al. (2020) and Fukuchi et al. (2019). While modern computation resources help very large CFD problems to be solved faster and give very accurate results (still slower than their 1D counterparts), they can be overkill for control objectives, and relatively large computation times for these problems are undesired. 1D lumped parameter modeling also offers accurate solutions with faster computations. These models provide enough accuracy for any control development and validation while providing a reduction in computation. One application in the performance evaluation of air-cooled condensers is shown in Ge and Cropper (2005). In (Steinstraeter et al. (2022), Widmer et al. (2022)), the authors proposed a technique to control the effect of cabin heating on the range and lifetime of electric vehicles and onboard battery packs.

Dynamic equations can describe the flow of a phase-changing fluid in an HX. He (2005) and Ge and Cropper (2005). Both methods start with the first principles-using finite volume equations for the conservation of energy, momentum, and mass as Partial Differential Equations (PDEs). To account for the changing phase of the fluid, they divide the HX into zones representing different phases, i.e., liquid, two-phase, and gas.

He (2005) defines a moving interface lumped parameter model in which the HX is divided into three sections/zones: two-phase; superheat; and sub cool zones with lengths L1, L2, and L3. They integrated the PDEs for the conservation of mass, energy, and momentum over the length of the HX to form a set of Ordinary Differential Equations (ODEs) in pressure and void fraction. Furthermore, Ge and Cropper (2005) split the two-phase region into two regions at a 3:2 ratio because of the rapid rise in the heat transfer. With this approach, the error in their models was ±10% of the experimental value.

The present disclosure includes HX models. Zhang et al. (2015). The HX models developed in the present disclosure can support energy estimation during the hotel period of a class 8 truck using rule-based control.

The present disclosure includes a fundamental approach that can be incorporated in a controller [Lustbader et al. (2011), Richter (2008) Tummescheit et al. (2005), Tummescheit (2002)]. A grey-box modeling approach is disclosed hereinand some calibration parameters are included like the heat transfer coefficient of an HX, which itself is calculated using the e-NTU method [Browne and Bansal (1998)]. CoolProp, RefProp [McLinden (1998)], is used to calculate internal fluid properties as needed. The present disclosure can include approaches to calculate the compressor work by assuming polytropic work between two pressures at the HX with isentropic correction.

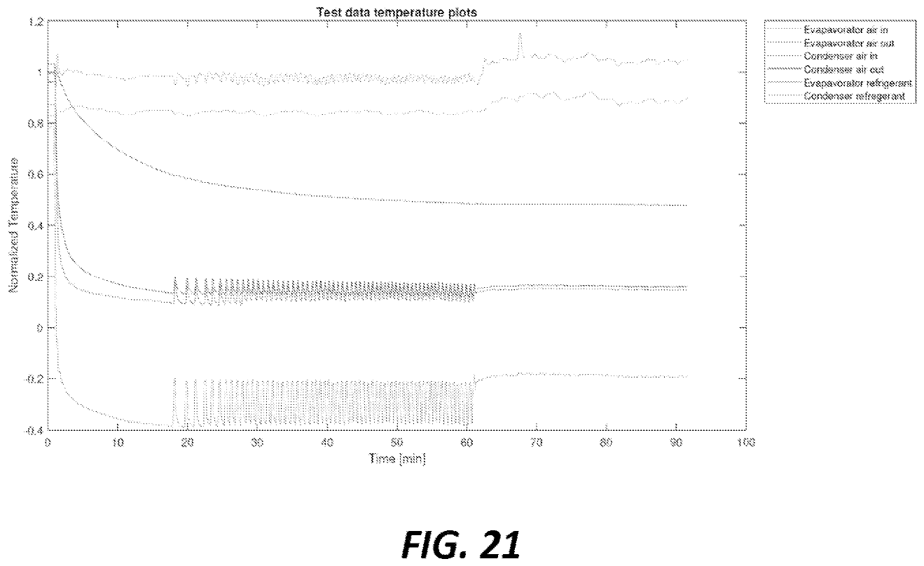

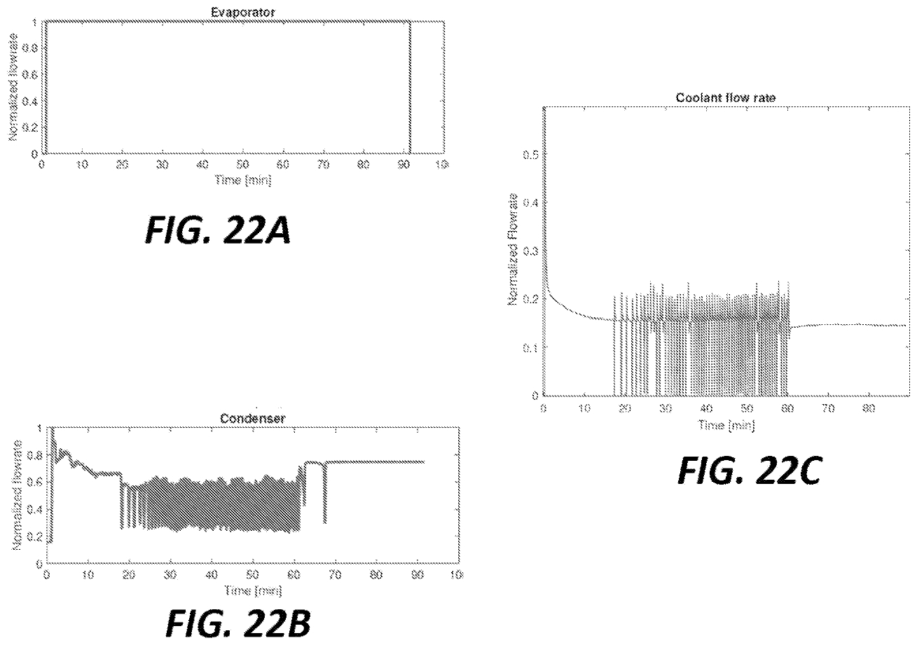

The data that is used for calibration comes from the same data set as that used in cabin model calibration. Example quantities are shown in FIG. 21. The evaporator air in and out temperatures are the temperatures of the recirculating air fed to the evaporator from the cabin and the air blown from the AC vents on the dashboard respectively and the corresponding air flow rate is shown in FIG. 22A along with the condenser cross air flow rate (FIG. 22B) which is placed in front of the radiator module and is air-cooled through the ram air effect. The radiator fans control the cross-air flow rate at the radiator face. While the study can use the air flow rate at the face of the radiator, the metric may not be available from the test. Since the test captures the radiator fan RPM the example implementation can use that to calculate the air flow rate using the Eq. 10. It can be seen from Eq. 10, the airflow rate depends on the density of air, RPM of the radiator fan, and some design parameters of the radiator which are not available. To bridge this gap, the study used data Wang et al. (2014) for a similar size radiator and use appropriate scaling.

$${\dot{m}}_{f} = \frac{4 {π}^{2} {ρ}_{air} {r}_{m}^{3} {Φ}_{m} N n}{60} ( \frac{1 - {v}^{′ 2}}{1 + {v}^{2}} ) \qquad ( 10 )$$

The frontal area of the radiator is assumed from the market survey for radiators used in vehicles of similar size [Kenworth and Peterbilt (2012)], and then ram air speed [mph] is converted into air flow rate [kg/s] considering the loss in flow rate at the grill of the vehicle. Using the information provided in Wang et al. (2014), a correlation is established between the air flow rate and the radiator RPM and then RPM is converted into the flow rate for the condenser air flow rate and is shown in FIG. 22A which shows the evaporator flow rate, and FIG. 22B which shows the condenser flow rate. Total coolant flow rate is illustrated in FIG. 22C.

In Supertruck II, an example strategy is to maintain a 5° C. sub-cool and a 10° C. super-heat. However, from the test data procedure, the EXV and the compressor speed are manually controlled and sometimes they counteract each other to produce inconsistent superheat and subcooling. Hence, for the right calibration, this information is fed directly into the model. The fluctuations in the data from the time at t=20 minutes to t=60 minutes are due to engaging and disengaging an AC clutch that regulates the compressor speed. The refrigerant flow rate is captured in FIG. 22B.

In order to represent the pressures at the HXs, some assumptions can be used reduce the computation effort without significant compromise on accuracy. These assumptions pertain to the HX component and the complete vapor compressor cycle as well.

The refrigerant can be described completely with Pressure (P) and average vapor quality (x) in the HX. The heat is exchanged only through walls of the HX lateral to the direction of flow of refrigerant. There is no heat loss in the direction of the flow of the refrigerant. The walls are thin enough to not have any loss of heat at the walls and the wall can be lumped with the refrigerant.

Heat transfer coefficient across the heat exchanger is constant.

Refrigerant R134a does not deviate from its properties as shown in the ph graph in FIG. 20.

The pressure remains constant and there is no frictional loss in the HX. This allows the pressure of the refrigerant at the HX to be represented as a single state P.

$$( {P}_{c} = {P}_{c , i n} = {P}_{c , out} = {P}_{e , i n} = {P}_{e , out} )$$

The response for the pressure drop at the expansive valve is instantaneous with no change in the enthalpy of the refrigerant. (h₂=h₃)

The Superheat (SH) and subcool (SC) can be calibrated to achieve a constant superheat temperature ΔT_{SH}=T₄−T_{g}(Pe)=10° C. and a constant subcool temperature ΔT_{sc}=T₂−T₁(p_{c})=5° C.

Implementations of the present disclosure include a moving interface mathematical model.

The fundamental PDEs for the conservation of mass and energy are reduced, inspired from He (1996), and integrated over the length (L) of the HX. The final form is proposed based on average vapor quality (xₘ) and the two-phase pressure (P) in Khuntia et al. (2022c). The flow rate of the refrigerant entering and exiting the refrigerant is assumed to be constant hence reducing the two ODEs into one in Pressure as compared to that proposed in Singh (2021). The equation proposed in Singh (2021) is shown in eq (11) and the final reduced form is shown in eq (13).

$$\frac{V}{{v}_{m}^{2}} C \frac{d P}{dt} + \frac{V}{{v}_{m}^{2}} B \frac{d {X}_{m}}{dt} = {\dot{m}}_{i n} {h}_{i n} - {\dot{m}}_{out} {h}_{out} + \dot{Q} \qquad ( 11 )$$

$$\frac{- V}{{v}_{m}^{2}} D \frac{d P}{dt} + \frac{- V}{{v}_{m}^{2}} E \frac{d {X}_{m}}{d t} = {\dot{m}}_{i n} - {\dot{m}}_{o u t} \qquad ( 12 )$$

Considering no loss in flow rate, i.e.,

$${\dot{m}}_{i n} = {\dot{m}}_{out}$$

This reduces the above equations into one equation representing HX pressure dynamics:

$$\frac{V}{{v}_{m}^{2}} ( C - \frac{B D}{E} ) \frac{d P}{d t} = \dot{m} ( {h}_{i n} - {h}_{o u t} ) + \dot{Q} \qquad ( 13 )$$

Where,

$$C = {v}_{m} ( ( 1 - x ) \frac{d {h}_{l}}{dP} + x \frac{d {h}_{g}}{dP} ) - {h}_{m} ( ( 1 - x ) \frac{d {v}_{l}}{dP} + x \frac{d {v}_{g}}{dP} B = {v}_{m} ( {h}_{g} - {h}_{l} ) - {h}_{m} ( {v}_{g} - {v}_{l} ) D = ( 1 - x ) \frac{{dv}_{t}}{dP} + x \frac{d {v}_{g}}{dP} E = {v}_{g} - {v}_{1} {v}_{m} = ( 1 - {X}_{m} ) {v}_{l} + {X}_{m} {v}_{g} \qquad ( 14 )$$

$${h}_{m , e} = ( 1 - {X}_{m} ) {h}_{l} + {X}_{m} {h}_{g} \qquad ( 15 )$$

The heat rejected through the refrigerant into the secondary fluid at the HXs is represented as \dot{Q}. Going by the convention of the direction of flow of heat, the \dot{Q} for the evaporator and the condenser takes opposite signs. It can be calculated using the e-NTU method as it allows us to calculate the exit properties of the refrigerant using only the inlet properties and is highlighted in Eq. (16)

$$ϵ = \frac{{\dot{Q}}_{a c t}}{{\dot{Q}}_{max}} = 1 - {e}^{- N T U} \qquad ( 16 )$$

$${\dot{Q}}_{act} = {C}_{air} ( {T}_{air , out} - {T}_{air , in} ) = {C}_{r e f} ( {T}_{ref} - {T}_{ref , o u t} ) \qquad ( 17 )$$

$${\dot{Q}}_{max} = {C}_{min} ( {T}_{h , in} - {T}_{c , in} ) \qquad ( 18 )$$

$$NTU = \frac{U A}{{C}_{min}} \qquad ( 19 )$$

The calibration activity for the HX is to estimate the overall heat transfer coefficient, UA. The UA is calculated based on the Eq. (20). It is highly dependent on the HX geometry which is constant for a particular HX and is provided in the supplier datasheet. The authors calibrate this as a lumped value. Although the heat transfer coefficient α is a function of the crossflowing air speed, hence is not constant. Due to limited data points and a limited range of operation, it can be assumed as a constant.

$$UA = α [ 1 - {F}_{fin} ( 1 - {η}_{fin} ) ] {A}_{s} \qquad ( 20 )$$

By inverting the relationship between the air side and the coolant side heat transfer (shown in Eq. (22) for the evaporator and Eq. (21) for condenser) the study determined the exit air temperatures.

$${\dot{Q}}_{e} = {\dot{m}}_{air} {cp}_{air} = ( {T}_{air , in} - {T}_{air , out} ) \qquad ( 21 )$$

$${\dot{Q}}_{c} = {\dot{m}}_{air} {cp}_{air} ( {a}_{air , in} - {T}_{air , out} ) \qquad ( 22 )$$

Using the definition of effectiveness:

$${T}_{air , out} = {T}_{e} + ( {T}_{air , in} - {T}_{e} ) {e}^{- {NTU}_{e}} \qquad ( 23 )$$

$${T}_{air , out} = {T}_{c} + ( {T}_{air , in} - {T}_{e} ) {e}^{- {NTU}_{c}} \qquad ( 24 )$$

The equation Eq. (25) represents the final model equation by using Eq. (19) to Eq. (24) along with the mention of the calibration parameters in red.

$$\frac{V}{{v}_{m}^{2}} ( C - \frac{BD}{E} ) \frac{dP}{dt} = M [ \dot{m} ( {h}_{in} - {h}_{out} ) + q {\dot{m}}_{air} {cp}_{air} ( {τ}_{air , in} - {T}_{HX} + ( {T}_{air , in} - {T}_{HX} ) {e}^{- \frac{U A}{{m}_{air} {c}_{air}}} ) ] \qquad ( 25 )$$

Two calibration parameters ‘q’ and ‘M’ other than the UA are added. The parameter ‘M’ helps in better capturing the transience in the data. The UA is the overall heat transfer coefficient as discussed earlier in this work. q is a correction term for the inaccuracies that may have come about due to the estimation of flow rates. The calibration parameter ‘q’ acts as the larger knob for tuning the heat exchange pressure while the UA acts as the fine-tuning knob.

At the condenser, the refrigerant exits as a sub-cooled liquid. While going through the EXV, its pressure drops at a constant enthalpy and enters the evaporator as a two-phase fluid. The pressure and the sub-cool at the condenser are used to identify the enthalpy, and the pressure at the evaporator is used to pinpoint the properties of the refrigerant from the ph curve (FIG. 20).

The refrigerant properties are calculated using a free property open source software COOLPROP using the python wrapper Bell et al. (2014) in MATLAB.

The refrigerant exits the evaporator as a superheated gas. This helps in avoiding any liquid entering the compressor. However, the degree of superheat is kept small as very hot and dry gas entering the compressor can also sabotage the machine.

$$\frac{{V}_{e}}{{v}_{m , e}^{2}} ( {C}_{e} - \frac{{B}_{e} {D}_{e}}{{E}_{e}} ) \frac{{dP}_{e}}{dt} = {M}_{e} [ {\dot{m}}_{ref} ( {h}_{3} - {h}_{4} ) + {q}_{e} {\dot{Q}}_{e} ] \qquad ( 26 )$$

$$\frac{- {D}_{e}}{{E}_{e}} \frac{{dP}_{e}}{dt} = \frac{{dX}_{m , e}}{dt} \qquad ( 27 )$$

$${\dot{Q}}_{e} = {\dot{m}}_{air} {cp}_{air} ( {T}_{air , in} - {T}_{e} + ( {T}_{air , in} - {T}_{e} ) ( {e}^{- \frac{UAe}{{\dot{m}}_{air} {cp}_{air}}} ) \qquad ( 28 )$$

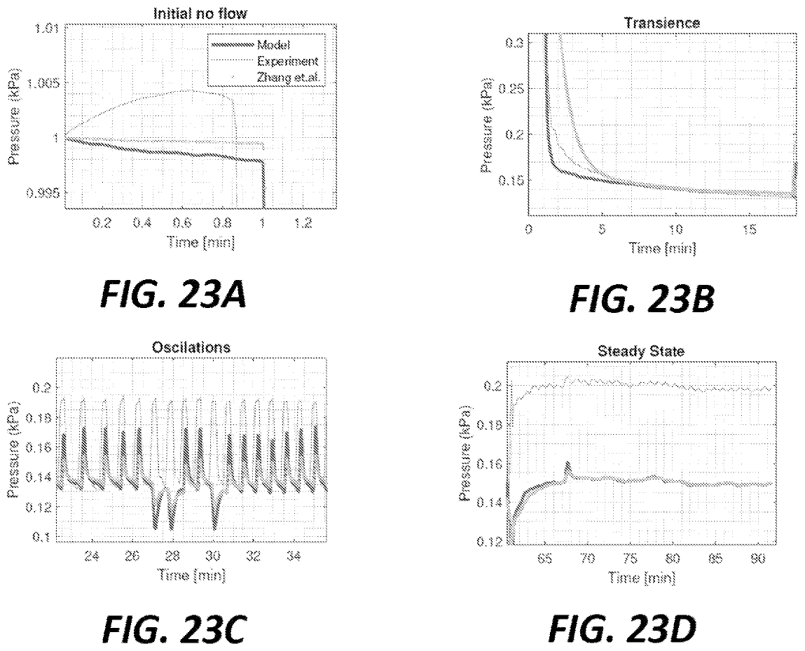

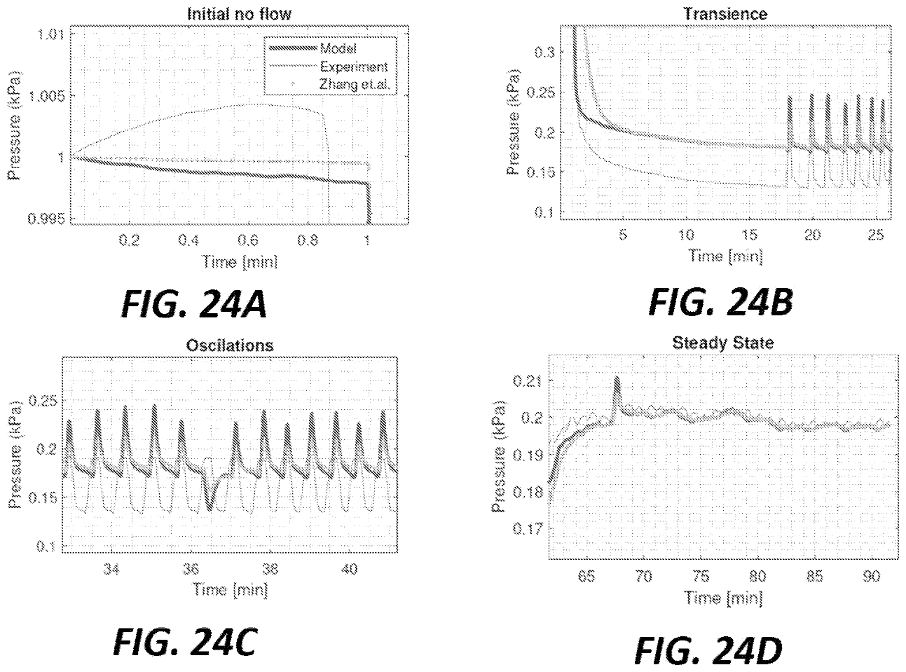

For the calibration process, first NTU is back-calculated using empirical relationships and using one steady state data point for the inlet and exit temperatures of the refrigerant. Then qₑ and Mₑ are manually tuned. The equations are executed in the MATLAB/Simulink environment and the results are shown in FIGS. 23A-23D. The results of the simulation and the data did not match as expected. There are inconsistencies that can be seen. One arises mainly during the AC clutch ON-OFF action. It is also reasonable since the model being lumped parameter working with the given assumptions can capture the bulk average behavior but not the behavior with the high transience. The second inconsistency can be seen after t=60 min. The pressure trajectory predicted by the model is the same as that of the data but shifted by a few units up. To match the shift in pressure, the model is re-tuned and another set of parameters is used and the results are shown in FIGS. 24A-24D. While one set of values for UAₑ, qₑ, Mₑ satisfied the transient behavior while another set of parameters satisfied the steady-state values.

This discrepancy is further investigated. Matching the pressure dynamics from the data to the refrigerant flow rate (FIG. 22B) it was seen that the flow rate is increased occasionally when the compressor engages and disengages. This should indicate the pressure to decrease at the suction. This is predicted by the model but not indicated by the data. At time t=60 min, the oscillations are stopped, the data displays the oscillations to have stopped at a higher pressure, but the model indicates the oscillations to be stopped at the lower pressure value. This explains the shift in the pressure indicated by the model and the data.

The model does not seem to replicate the data exactly, but the pattern and trends predicted by the model and the data are similar. Possible sources of error can include: missing information in the data including which in the modeling should reduce the error and/or that the assumptions in the model make it incapable to capture the pressure dynamics of the HX pressure accurately.

To check the validity of the example model and identify the source of the error, another model (Zhang and Canova (2013)) was chosen and compared to the existing results later. This model relies on the time-invariant mean void fraction in the two-phase region of an HX to calculate its pressure. This model is verified against experimental data and so serves as a good baseline for comparison. The model however demands an additional calibration parameter for the weight of the refrigerant at the HX and the definition of the void fraction for this model is estimated (Dandekar and Brooks (2016)) and is shown in Eq. (29):

$${\overline{γ}}_{e} = \frac{1}{1 - {v}_{a}} + \frac{{v}_{a}}{( 1 - {x}_{3} ) {( 1 - {v}_{a} )}^{2}} ln ( {v}_{a} + ( 1 - {v}_{a} ) {x}_{3} ) \qquad ( 29 )$$

Where,

$${v}_{a} = \frac{{v}_{3}^{2 / 3}}{{v}_{g}} \qquad ( 30 )$$

FIG. 23A-24D illustrates calibrated evaporator models comparison on 4 segments of the data. FIG. 23A illustrates initial no flow, FIG. 23B illustrates transience FIG. 23C illustrates flow rate oscillations; FIG. 24D illustrates steady-state with calibration parameter set 1.

It can be seen from FIG. 23A-24D that in the first segment where the flow rate is 0, both the proposed model and Zhang et. al. model do not capture the increase in the pressure. Following that, both models closely capture the transience and both reach the same steady state value at nearly the same time as indicated by the data. Both models do not capture the oscillations but show the same trend. The steady-state condition at the end is not tracked by either of the models but both show a similar trend and are nearly identical to each other. The steady state is however reached a little before but overall, the models are consistent with each other and the last portion of the data.

Breaking down the response segment-wise can also be used to show clearer results, as shown in FIGS. 24A-24D. The two models match each other but they can be disconnected from the data at some points. While the oscillations are still captured, they are not captured with the same magnitude however the steady state is captured by both models accurately. They can hence be of use to capture the overall averaged pressure which can be used for energy estimation.

FIGS. 24A-24D illustrate calibrated evaporator models comparison on 4 segments of the data. FIG. 24A illustrates initial no flow. FIG. 24B illustrates transience. FIG. 24C illustrates flow rate oscillations. FIG. 24D illustrates steady-state with calibration parameter set 2.

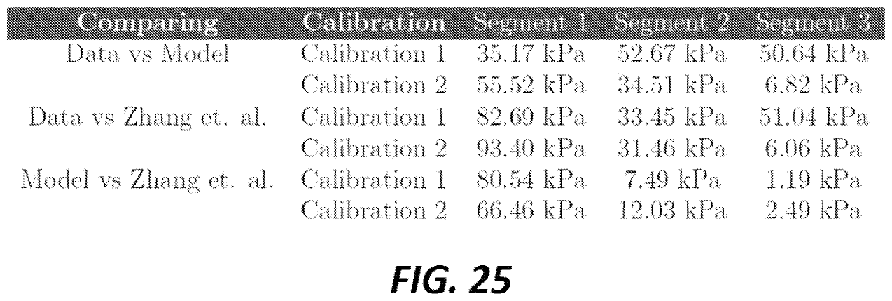

FIG. 25 illustrates a summary of the RMSE for each segment of a evaporator pressure using both models (proposed model and Zhang model). It is clear that the proposed model shows a better response in representing the real data.

This solidifies the accuracy of the evaporator model and this is then used and calibrate the condenser. The refrigerant enters the condenser as a superheated gas and starts turning into two-phase at the saturated vapor line. It liquefies as it moves towards the saturated liquid line where it changes completely into liquid. Thereafter it changes to a subcooled liquid and then the refrigerant enters the EXV to be depressurized for the evaporator.

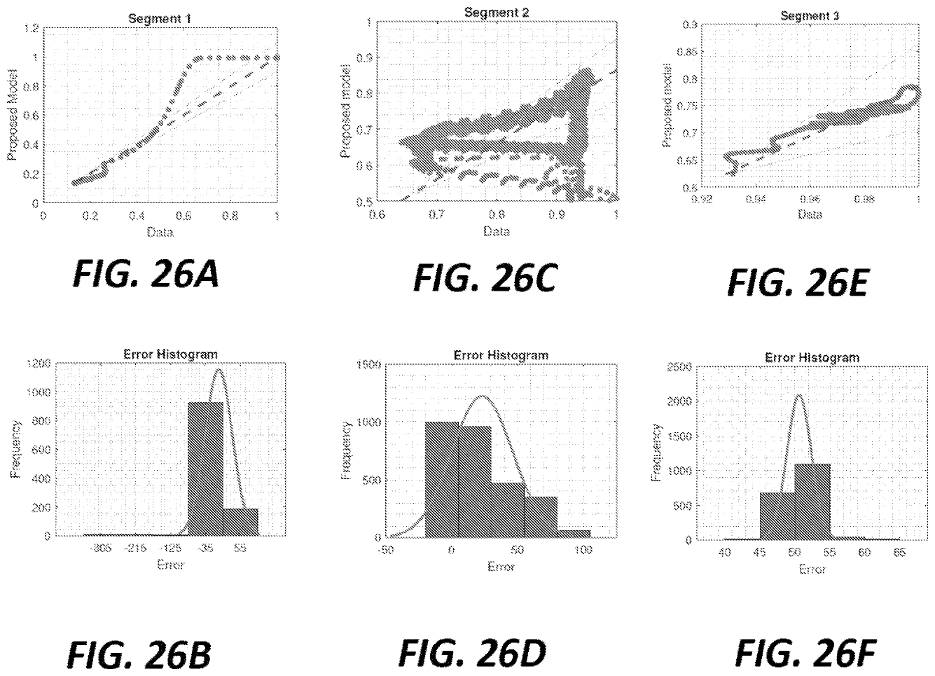

FIGS. 26A-26F illustrate experimental data compared to a proposed model error study on calibration parameter set 1, according to the studied implementation of the present disclosure. FIG. 26A illustrates a comparison of experimental data to the proposed model for segment 1. FIG. 26B illustrates an error histogram for segment 1. FIG. 26C illustrates a comparison of experimental data to the proposed model for segment 1. FIG. 26D illustrates an error histogram for segment 1. FIG. 26E illustrates a comparison of experimental data to the proposed model for segment 1. FIG. 26F illustrates an error histogram for segment 1.

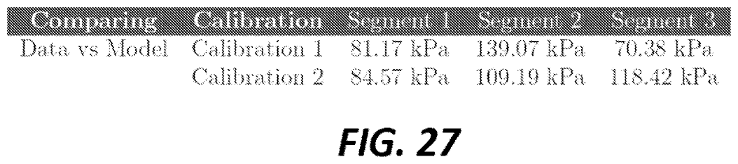

FIG. 27 illustrates a comparison of RMSE error for models of example condenser pressures.

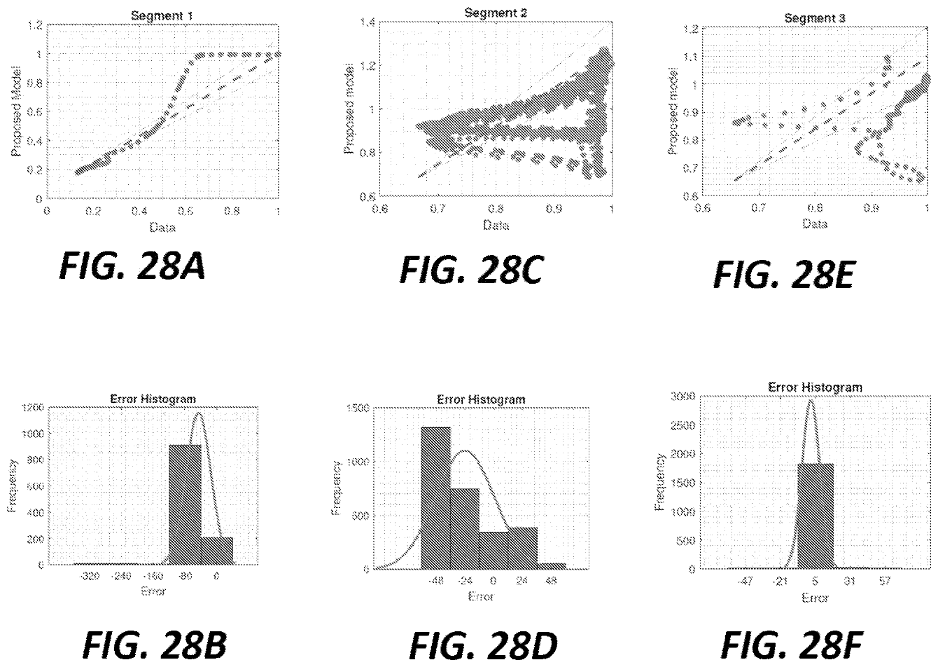

FIGS. 28A-28F illustrate experimental data compared to a proposed model error study on calibration parameter set 2, according to A studied implementation of the present disclosure. FIG. 28A illustrates a comparison of experimental data to the proposed model for segment 1. FIG. 28B illustrates an error histogram for segment 1. FIG. 28C illustrates a comparison of experimental data to the proposed model for segment 1. FIG. 28D illustrates an error histogram for segment 1. FIG. 28E illustrates a comparison of experimental data to the proposed model for segment 1. FIG. 28F illustrates an error histogram for segment 1.

Similar to the evaporator model, the condenser can also optionally have two sets of parameters since the pressure dynamics are coupled. One captures the first portion well while the other captures the end steady state. As the flow rate oscillations change the pressure dynamics change direction, however, the data doesn't suggest any of these switches. On analyzing section-wise it can be seen that segments 1 and 3 are in the acceptable range, while segment 2, due to the oscillation shows a high deviation from the data more than the 10% reference.

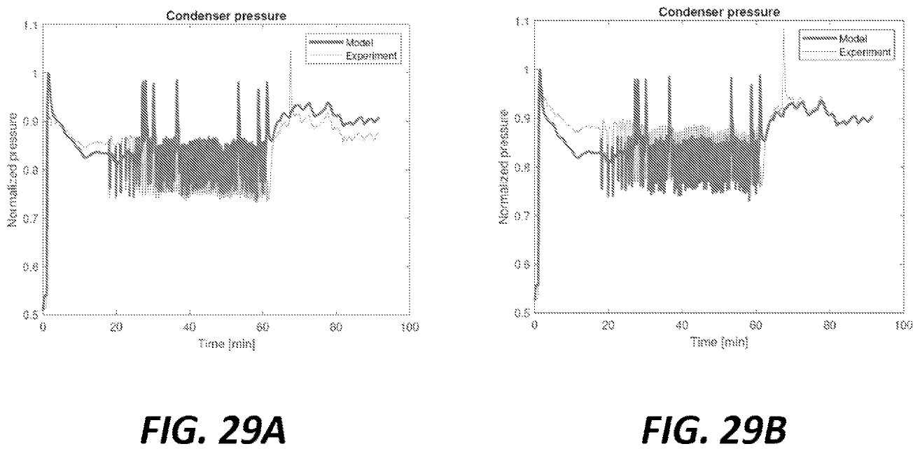

FIG. 29A illustrates condenser pressure with parameter set 1, and FIG. 29B illustrates condenser pressure with parameter set 2. FIG. 29B shows that segment 2 shows similar behavior, even in terms of the magnitude of the error. While segment 1 is captured well, segment 3 shows a high deviation from data and the ±10% deviation. This is due to the spike that wasn't captured in the model at time t=70 min.

The compressor regulates the flow rate and hence the pressure difference to achieve the right cooling effect. In this application, an electric compressor is used which converts the battery energy to mechanical work with some electrical efficiency. The other losses associated with the compressor are the (1) isentropic losses when the compressor displays some deviation from the isotropic line when increasing the pressure from Pₑ to P_{c}, (2) volumetric efficiency where the amount of refrigerant entering is not the same as the amount of refrigerant exiting the compressor, i.e., the idealistic reduction in the compressor capacity, (3) electrical and mechanical losses, i.e. when converting electric work to mechanical work and losses due to friction.

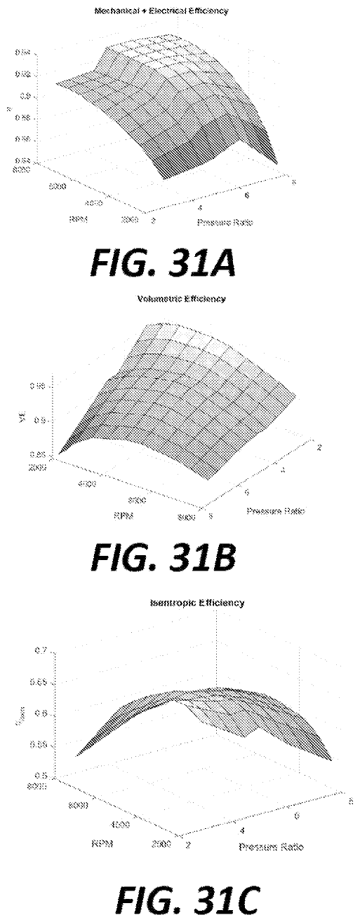

These losses are captured as quasi-static elements as a function of the pressure ratio and the RPM of the compressor using steady-state data. FIG. 31A, FIG. 31B, and FIG. 31C show the maps used for the mechanical and electrical efficiency combined, volumetric efficiency and the isentropic efficiency. FIG. 31A illustrates mechanical and electrical efficiency, FIG. 31B illustrates volumetric efficiency, and FIG. 31C illustrates isotropic efficiency.

The volumetric efficiency is used to calculate the mass flow rate given the volumetric displacement as in Eq. (31).

$${η}_{v} = \frac{\dot{m} {v}_{e}}{{\dot{V}}_{disp}} \qquad ( 31 )$$

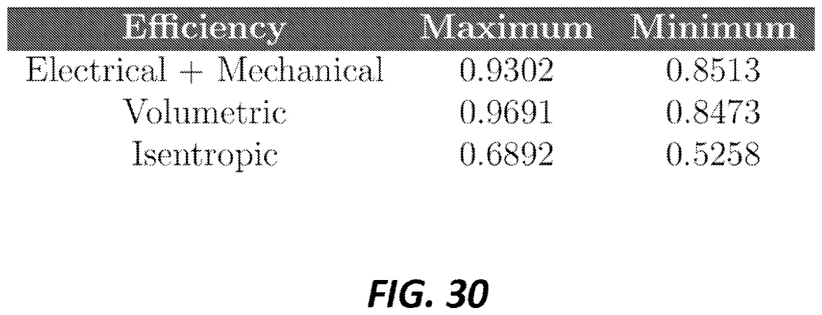

FIG. 30 shows a range of efficiency values at the compressor, for the example implementation studied. The isentropic efficiency is used to find the enthalpy at the exit of the compressor or the entry of the condenser using the relation in Eq. (32).

$${h}_{1} = {h}_{4} + \frac{{h}_{1 , s} - {h}_{4}}{{η}_{isen} ( {P}_{ratio} , RPM )} \qquad ( 32 )$$

The polytropic index for this process is calculated using the relationship shown in Eq. (33) and is observed to have a mean of 1.08 and a standard deviation of 0.016 for the entire data, and hence is used as a constant for the simulation.

$$n = \frac{log ( {P}_{ratio} )}{log ( {ρ}_{out} / {ρ}_{in} )} \qquad ( 33 )$$

The polytropic work is used to calculate the compressor work as:

$${W}_{poly} = \frac{n}{n - 1} {P}_{e} {V}_{e} ( {\frac{{P}_{c}}{{P}_{e}}}^{\frac{n - 1}{n}} - 1 ) \qquad ( 34 )$$

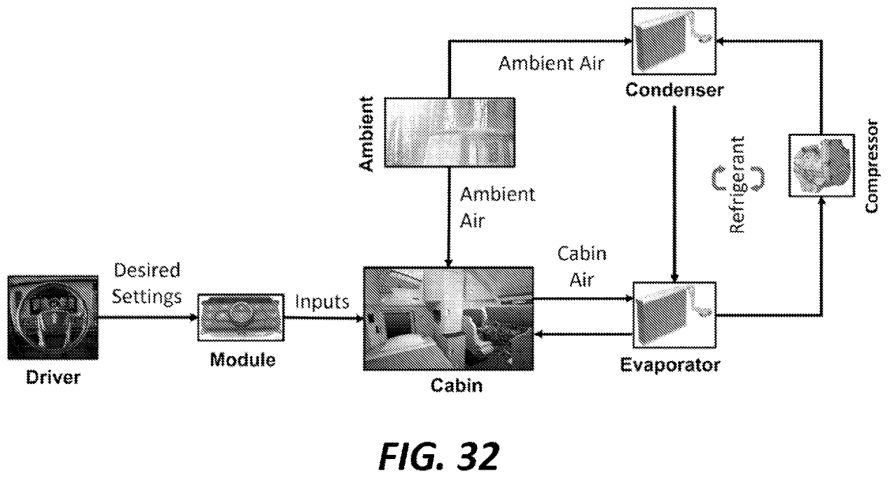

All the pieces discussed with respect to the present example tie into a full-cycle simulator capturing the coupling between the vapor compression cycle, i.e., HXs, compressor, and cabin, and is shown in FIG. 32. An ‘Ambient’ subsystem that describes the external conditions of the system like the solar GHI, ambient temperature, and relative wind speed. A setpoint temperature is set at the driver subsystem and the control module is a placeholder for any control strategy desired to be implemented in the system. The current simulation is run with a cabin vent blower and compressor and radiator fan RPM control.

The objective of this simulator is to calculate the compressor power to maintain a certain temperature at the cabin and also to study any control development. As an example, a cabin modeling section of Khuntia et al. (2022a) is emulated and the corresponding load is calculated. That is maintaining the cabin at a setpoint temperature of 24.5° C.

It was found that due to the size of the cabin, the temperature of the recirculating air going into the evaporator was not the same as the average cabin temperature. However, it had similar dynamics to it. Hence a pseudo node is introduced and added to the cabin model that represents the air entering the evaporator.

$${C}_{hvac} \frac{{dT}_{c}}{dt} = {H}_{win , c} ( {T}_{w} - {T}_{c} ) + {H}_{roof , c} ( {T}_{roof} - {T}_{c} ) + γ \dot{m} {cp}_{air} ( {T}_{hvac} - {T}_{cab} )$$

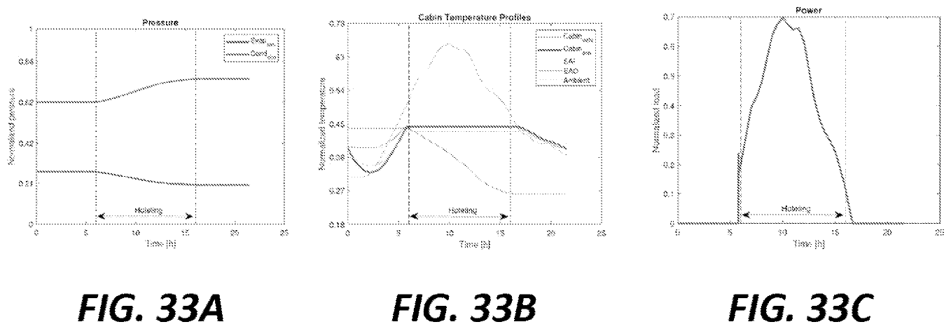

A 10 hour hoteling period is simulated and the control inputs are designed as a rules-based controller, the results and the control actions are shown in FIGS. 33A-33C. The model is calibrated for AC operations. It can be seen in FIG. 33B that the data for cabin internal air temperature is provided. In the experiment, until time t=4 h, the HVAC is operated as a heat pump. As the daytime temperature rises the cabin is maintained at a setpoint temperature and as the temperature falls, the cabin temperature also falls. The load corresponding to the hoteling period is calculated and is shown in FIG. 33C and the corresponding evaporator and condenser pressure is shown in FIG. 33A. It is worth noting that as the temperature of the cabin needs to be maintained, the pressure of the refrigerant has to fall to be able to lower its own temperature for effective heat transfer, while at the condenser the temperature has to increase higher for effective heat transfer with the

If the model is not calibrated as a heat pump, it is not activated when it should be used for heating, hence it takes longer to rise to the setpoint temperature.

No cross-flowing air at the condenser end can help in the rise of pressure at the condenser. Condenser fans are turned off at this time. When they turned on, the pressure at the condenser decreased. The compressor RPM is commanded using the difference in the ambient and the cabin inlet temperature, and it in turn commands a flow rate for the refrigerant using the relationship in Eq. (31). FIG. 33C shows the corresponding electrical power. This is only corresponding to the compressor work and not the vent blowers in the cabin. The total energy required at the compressor was found to be 15.21 kWhr.

Implementations of the present disclosure can include a data driven Model. HVAC may not be the only source of load on the onboard battery pack during the hotel period. The driver engages in activities like having food/drinks, relaxing, and watching TV. The cabin in a long-haul sleeper truck comes equipped with devices to support these activities like a microwave, refrigerators, etc. There is a load associated with using these devices. The time and duration of using these activities (device usage) determines the total energy consumption during the hotel period as shown in FIG. 4. While HVAC load can be predicted using Physics-based HVAC modeling, the example implementation can capture the other activities of the driver using Machine Learning techniques.

Any machine learning model requires a lot of data to be trained on. In this case, the data is the time and duration of a corresponding device being used during the 10-hour hotel period. Currently, this data is not being actively recorded on the truck, and in cases where it is recorded, it is not easily available to be shared. It is also not possible to have enough survey data to supplement the training of a Neural Network (NN) which can require 100's of data points to be accurate enough. Hence, the synthetic data is generated in this work based on the existing survey samples.

FIG. 4 illustrates different activities and the x-axis shows the different time stamps. FIG. 4 represents the survey data recorded for the SuperTruck project. While some of these activities require the use of an electrical appliance like a TV, the ones that don't are represented by OW. FIG. 5 represents the normalized electric power for the 10 hours of the hotel period for these activities. The majority of the time the load is low and there are some large spikes in the data. These spikes correspond to the microwave and the coffee maker is turned on. The long during between the two sets of spikes is the time in which the driver sleeps. The other loads can considered be small and insignificant.

According to implementations of the present disclosure, predicting the duration of each activity independently is a multivariate problem and increases the complexity of the machine learning problem. By adding all the corresponding loads at a particular time stamp, such as shown in FIG. 5 and predicting this profile can reduce this multi-variate problem to a uni-variate problem eliminating the need for creating categories/labels for each activity/group of activities. The long and Short Term Memory (LSTM) algorithm can be used in implementations of the present disclosure for predicting this time series data and is set up as a regression problem. The input and output are set up as a predictor response format where a series is fed as an input and the output is a value representing the power load at the next time instant. For the first time step, the problem is set as one-to-one and then changes to a many-to-one prediction from time to step two as the prediction is stacked to the input.

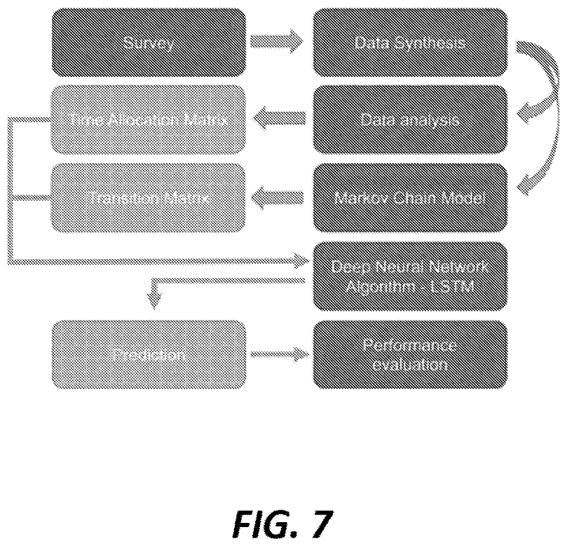

The first survey is used to generate enough data sets to train a machine learning algorithm. A Time Allocation Matrix (TAM) and a Transition Matrix (TM) are extracted from it. A combination of the two along with a power load vector is fed as the input to the NN. The algorithm gives some predictions which are then evaluated and the performance is reported. A flowchart of the algorithm configuration for the example implementation is illustrated as FIG. 7.

The temporal information is captured using the probability distribution for each activity and can be seen in FIG. 8 for the driver sleeping, using the microwave, and using the coffee maker activities. The TM is developed using Markov property Gagniuc (2017). For n-activities a n-by-n matrix is generated, in which the element l-by-m [l, m∈n] would store the probability of going from activity I to activity m at any instant.

The non-limiting example algorithm in the study was set up as:
(1) Split the data into training and test sets in a 9:1 ratio
(2) Create predictor x^{<1:T}^{ₓ₋₁}> and response x^{<2:T}^{ₓ}> for the training sequences where Tₓ is the length of the series.
(3) Row wise append the predictor with TAM and TM, i.e., create the input matrix. and train the network.
(4) Use the trained network to predict the test day. An initial guess of x^{<1>} is 0 and a prediction y^{<1>} is made. This prediction is column wise appended to x^{<1>} as x^{<2>} and a prediction for 3rd time step, i.e., y^{<2>} is made until y^{<T}^{_{y}}^{>}

The performance of the algorithm can be improved by the standardization of the power load. MATLAB NN toolbox was used to define the architecture of the LSTM algorithm and is summarized below. The algorithm is trained using an ‘adam’ solver with an initial learning rate of 0.005 and a gradient threshold of 1 for 250 epochs.
(1) Input Layer: With 25 features
(2) LSTM Layer: With 50 hidden units
(3) LSTM Layer: With 50 hidden units
(4) Fully Connected Layer: Multiplies the input weight matrix and adds the bias vector.
(5) Regression Layer: Compares the mean squared error.

The right compromise between the computation time and accuracy is suggested using 2 layers. In order to capture the minor trends in the data a two-layer deep LSTM is used. Adding another LSTM layer increases the computation time exponentially high.

The study included model validation. Characterization of the accuracy of the prediction can be used to define the performance of the algorithm and also the hyperparameter tuning. Euclidean distance with Dynamic Time Warping (DTW) is hence used. While having the total energy consumption as a metric can be useful, it would give an error averaged over the complete prediction horizon. Instantaneous predicted power needs to be checked and this is where DTW becomes useful. Using the RMSE error after warping the time axis

The two hyper-parameters define the size of the network as well as determine the computation time. The number of hidden units chosen is [20 50 100 150] while the training period is [10 204070100140 200]. A visualization of the errors for the different combinations is given in FIG. 9 as the surface plot of the error matrix, this is the Euclidean distance measured point-wise on the warped time axis.

Since the optimization did not follow a pattern, a grid exhaustive search determines the minimum error at 50 hidden units and a training period of 20 days. The results with this combination are reported in FIGS. 10A and 10B.

FIG. 10A shows the forecast and the prediction as is while FIG. 10B shows its warped version. Different overlapping regions show the accuracy of the model. However it must be noted that warping may not be used for the final prediction, but only to gauge the accuracy of the model. It is irrelevant to capture the exact times of the activities and more important to capture the overall trend. For instance, it is more important to have the larger spikes corresponding to the usage of microwave and coffee maker to be at the start and the end of the hoteling leaving the time in the middle for the sleeping activity.

The two-layer LSTM algorithm trained on 20 days of data with 50 hidden units achieved 90% accuracy in total energy prediction calculated as the integrated sum of power over time. A 32 GB RAM, 2.2 GHz clock rate, and 64-bit processor computer are expected to take 4 minutes for the computation.

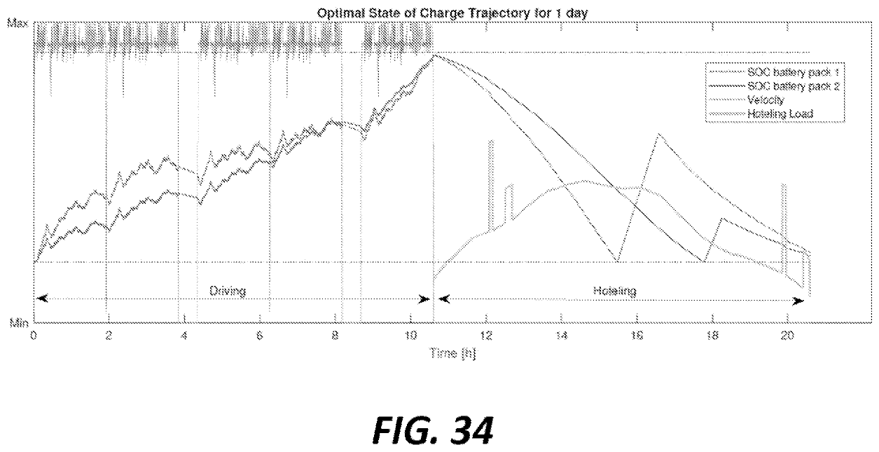

The study included an evaluation of an example drive cycle corresponding to a full day of a class 8 vehicle on a long-haul journey is developed adhering to federal laws. The example vehicle is a mild hybrid vehicle where the electric motor only works as a generator to charge the onboard battery pack during the drive phase. FIG. 34 illustrates the drive cycle and includes drive and hotel phases. The drive cycle of FIG. 34 is generated by repeating a smaller drive cycle defined for the SuperTruckII. The driver is on-duty for 11 hours with two 30-minute rests and hotels for 10 hours.

The models presented in this paper estimate the total energy required during the 10-hour hotel period. This is a combination of the HVAC load (FIG. 33C) calculated using the physics-based models and the load from the activities of the driver is predicted using the LSTM algorithm (FIGS. 10A and 10B). This is also illustrated in FIG. 34.

After determining the energy consumption, a corresponding initial (beginning of hotel period) battery's SOC is determined. An optimal SOC trajectory is calculated using an optimal control-dynamic programming algorithm that finds the optimal instances to recharge the battery, This can be done by running the engine at a more efficient operating point while transferring additional energy to the battery or regeneration from the wheels Singh et al. (2022). Dynamic programming, being a non-causal optimization method, requires all the information about the route and power loads from the auxiliary devices ahead of time.

The SOC is displayed in FIG. 34. These two lines correspond to two different battery packs (battery pack-1 and battery pack-2), the smaller-dotted blue, and the larger pack-solid blue. In this case, the energy required to support hotel loads is higher than the battery capacity hence the battery needs to be charged fully before the hotel period starts. The battery starts being used as the driver is resting inside the truck and using the auxiliaries. Correspondingly the SOC starts to drop until it reaches the minimum allowable SOC. At this point, the engine has to be idle to charge the onboard battery pack only to the amount as is required for the rest of the hotel period avoiding the 10 hour hoteling which is prevalent in trucks with conventional powertrains. The smaller battery requires 1.09 hours of additional idling to support this operation while the larger pack required only 27.8 minutes of idling.

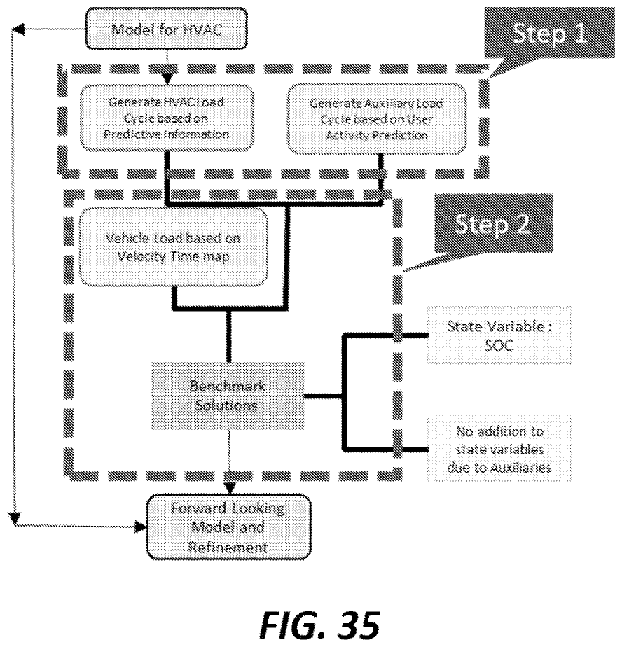

FIG. 35 illustrates an example system according to implementations of the present disclosure. HVAC load cycle information can be predicted, and user activity can be predicted. The HVAC load cycle information and user activity predictions can be used to determine a state of charge (“SOC”). Optionally, the models shown in FIG. 35 can be refined based on the actual user activities and/or actual HVAC load.

Implementations of the present disclosure include systems and methods to estimate the energy in hybrid class 8 long haul trucks during hoteling and/or use that information to increase the freight efficiency of the vehicle achieved using an optimal control algorithm called dynamic programming. A full day of simulation is used herein to show the results. The estimation of energy during hoteling is estimated using physics-based modeling and machine learning. Thermal models for the components in a vapor compressor cycle are developed from the first principles. The HX is modeled using the moving boundary method and the compressor is modeled using empirical relationships. A 2-node and 3-node cabin model is explored to estimate the temperature of the cabin at all times. Loads other than the HVAC loads, concerning the use of different devices are predicted using time series forecasting using a Recurrent Neural Network (RNN) called LSTM. An example 2 layer LSTM model uses 20 days of data to predict one full 10 hour hoteling. A 20-day moving window can be used to ensure consistent low-energy training and accuracy. Both models can work separately to produce a 10 hour hoteling load that is ultimately combined and used together in the optimal control algorithm.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
Administration, F. M. C. S. (2011). Interstate truck driver's guide to hours of service.
Aztiria, A., Augusto, J. C., Basagoiti, R., Izaguirre, A., and Cook, D. J. (2012). Discovering frequent user environment interactions in intelligent environments. Personal and Ubiquitous Computing, 16 (1), 91-103.
Gagniuc, P. A. (2017). Markov chains: from theory to implementation and experimentation. John Wiley & Sons.
Goutham, M., Stockar, S., Blaser, R., and Hanumalagutti, P. (2021). User activity sequence prediction in smart homes using multi-layer long short-term memory networks. IFAC-PapersOnLine, 54 (20), 901-906.
Goutham, M. (2020). Machine learning based user activity prediction for smart homes. Master's thesis, The Ohio State University.
Graves, A. (2013). Generating sequences with recurrent neural networks. arXiv preprint arXiv: 1308.0850.
Khuntia, S., Hanif, A., Singh, S. P., and Ahmed, Q. (2022). Control oriented model of cabin-hvac system in a longhaul class 8 trucks for energy management applications. Technical report, SAE Technical Paper.
Marufuzzaman, M., Reaz, M., Ali, M. A. M., and Rahman, L. (2015). A time series based sequence prediction algorithm to detect activities of daily living in smart home. Methods of information in medicine, 54 (03), 262270.
Minor, B., Doppa, J. R., and Cook, D. J. (2015). Data-driven activity prediction: Algorithms, evaluation methodology, and applications. In Proceedings of the 21th ACM SIGKDD International Conference on Knowledge Discovery and Data Mining, 805-814.
Mitler, M. M., Miller, J. C., Lipsitz, J. J., Walsh, J. K., and Wylie, C. D. (1997). The sleep of long-haul truck drivers. New England Journal of Medicine, 337 (11), 755-762.
Müller, M. (2007). Dynamic time warping. Information retrieval for music and motion, 69-84.
Smith, D., Ozpineci, B., Graves, R. L., Jones, P., Lustbader, J., Kelly, K., Walkowicz, K., Birky, A., Payne, G., Sigler, C., et al. (2020). Medium- and heavy-duty vehicle electrification: An assessment of technology and knowledge gaps. Technical report, Oak Ridge National Lab. (ORNL), Oak Ridge, TN (United States).
M. Margreta, C. Ford, R. Grube, et al., US freight on the move: highlights from the 2012 Commodity Flow Survey Preliminary Data, Technical Report, United States. Department of Transportation. Bureau of Transportation Statistics, 2014.
S. C. Davis, R. G. Boundy, Transportation energy data book: Edition 39, Technical Report, Oak Ridge National Lab. (ORNL), Oak Ridge, TN (United States), 2021.
O. Delgado, N. Lutsey, The us supertruck program, Washington DC (2014).
URL: https://www.energy.gov/eere/vehicles/articles.
Interstate truck driver's guide to hours of service (fmcsa) (2022). URL: https://www.fmcsa.dot.gov/regulations/hours-service/.
ANL, Idling reduction for long-haul trucks: An economic comparison of on-board and wayside technologies (2012). URL: https://publications. anl.gov/anlpubs/2016/10/130502.pdf.
L. Gains, Economics of idling reduction options for long-haul trucks (2017). URL: https://www.anl.gov/sites/wwW/files/2018-02. C.-J. Brodrick, N. P. Lutsey, Q. A. Keen, D. I. Rubins, J. P. Wallace, H. A. Dwyer, S. W. Gouse, Truck idling trends: Results of a pilot survey in northern california, in: SAE Technical Paper, SAE International, 2001. URL: https://doi.org/10.4271/2001-01-2828. doi: 10.4271/2001-01-2828.
F. Stodolsky, L. Gaines, A. Vyas, Analysis of technology options to reduce the fuel consumption of idling trucks, Technical Report, Argonne National Laboratory, 2000.
C. Kshirsagar, System Level Modeling and Optimization of Fuel Cell Powered Auxiliary Power Unit (APU) to be used in Commercial Vehicles, Technical Report, SAE Technical Paper, 2015.
B. Surampudi, J. Redfield, G. Ray, A. Montemayor, M. Walls, H. Mckee, T. Edwards, M. Lasecki, Electrification and integration of accessories on a class-8 tractor, in: SAE Technical Paper, SAE International, 2005. URL: https://doi.org/10.4271/2005-01-0016. doi: 10.4271/2005-01-0016.
B. Surampudi, M. Walls, J. Redfield, A. Montemayor, C. Ingold, J. Abela, 42-volt electric air conditioning system commissioning and control for a class-8 tractor, in: SAE Technical Paper, SAE International, 2004. URL: https://doi.org/10.4271/2004-01-1478. doi: 10.4271/2004-01-1478.
J. Redfield, B. Surampudi, R. Gustavo, A. Montemayor, H. McKee, T. Edwards, M. Lasecki, Accessory electrification in class 8 tractors, in: SAE Technical Paper, SAE International, 2006. URL: https://doi.org/10.4271/2006-01-0215. doi: 10.4271/2006-01-0215.
B. Surampudi, J. Redfield, A. Montemayor, G. Ray, G. Ostrowski, H. McKee, T. Edwards, A. S. Carstensen, J. C. Lawrence, Electric air conditioning for class 8 tractors, in: SAE Technical Paper, SAE International, 2006. URL: https://doi.org/10.4271/2006-01-0165. doi: 10.4271/2006-01-0165.
J. Campbell, W. Watts, D. Kittelson, Reduction of accessory overdrive and parasitic loading on a parallel electric hybrid city bus, in: SAE Technical Paper, SAE International, 2012. URL: https://doi.org/10.4271/2012-01-1005. doi: 10.4271/2012-01-1005.
S. P. Singh, A. Hanif, Q. Ahmed, M. Meijer, J. Lahti, Applied Energy 326 (2022) 119982. S. Khuntia, A. Hanif, S. P. Singh, Q. Ahmed, Control Oriented Model of Cabin-HVAC System in a Long-Haul Class 8 Trucks for Energy Management Applications, Technical Report, SAE Technical Paper, 2022a.
S. Khuntia, A. Hanif, Q. Ahmed, J. Lahti, M. Meijer, Cabin load prediction using time series forecasting in long-haul trucks for optimal energy management, IFAC-PapersOnLine 55 (2022b) 342-347.
S. Khuntia, A. Hanif, S. P. Singh, Q. Ahmed, Control Oriented Model of Cabin-HVAC System in a Long-Haul Trucks for Energy Management Applications, Technical Report, SAE Technical Paper, 2022c.
C. Okaeme, J. Lustbader, C. Sigler, I. Jorgensen, B. Grover, J. Kiesser, M. Moniot, Cabin thermal management analysis for supertruck ii nextgeneration hybrid electric truck design, SAE International Journal of Commercial Vehicles 14 (2021).
M. Altwieb, K. J. Kubiak, A. M. Aliyu, R. Mishra, A new three-dimensional cfd model for efficiency optimisation of fluid-to-air multi-fin heat exchanger, Thermal Science and Engineering Progress 19 (2020) 100658.
Y. Fukuchi, K. Yoshitake, K. Yokota, Development of simplified condenser model considering the effect of phase change, in: Proceedings of 12thFKFS Conference-Progress in Vehicle Aerodynamics and Thermal management, 2019.
Y. Ge, R. Cropper, Performance evaluations of air-cooled condensers using pure and mixture refrigerants by four-section lumped modelling methods, Applied thermal engineering 25 (2005) 1549-1564.
M. Steinstraeter, J. Buberger, K. Minnerup, D. Trifonov, P. Horner, B. Weiss, M. Lienkamp, Controlling cabin heating to improve range and battery lifetime of electric vehicles, ETransportation 13 (2022) 100181.
F. Widmer, A. Ritter, P. Duhr, C. H. Onder, Battery lifetime extension through optimal design and control of traction and heating systems in hybrid drivetrains, ETransportation 14 (2022) 100196.
X.-D. He, Dynamic modeling and multivariable control of vapor compression cycles in air conditioning systems (2005). Q. Zhang, S. Stockar, M. Canova, Energy-optimal control of an automotive air conditioning system for ancillary load reduction, IEEE Transactions on Control Systems Technology 24 (2015) 67-80.
J. A. Lustbader, J. P. Rugh, B. R. Rister, T. S. Venson, CoolCalc: a long-haul truck thermal load estimation tool, Technical Report, National Renewable Energy Lab. (NREL), Golden, CO (United States), 2011.
C. C. Richter, Proposal of new object-oriented equation-based model libraries for thermodynamic systems, Ph.D. thesis, Braunschweig, Techn. Univ., Diss., 2008, 2008.
H. Tummescheit, J. Eborn, K. Pr, Airconditioning—a modelica library for dynamic simulation of ac systems, 2005.
H. Tummescheit, Design and implementation of object-oriented model libraries using modelica, Ph.D. thesis, Lund University, 2002.
M. Browne, P. Bansal, An insight into the application of the ntu-? approach for modelling vapour-compression liquid chillers (1998).
M. O. McLinden, Nist thermodynamic and transport properties of refrigerants and refrigerant mixtures-refprop, NIST Standard Reference Database 23 (1998)
T. Wang, A. Jagarwal, J. R. Wagner, G. Fadel, Optimization of an automotive radiator fan array operation to reduce power consumption, IEEE/ASME Transactions on Mechatronics 20 (2014) 2359-2369.
Kenworth, Peterbilt, Kenworth: Peterbilt radiator: 2008-2011 t680, t880, t2000: 2008-2011nbsp; 365, 367, 387:2011-2012nbsp; 587, American Radiator Pros (2012). URL: https://radiatorpros.com.
T. Wang, A. Jagarwal, J. R. Wagner, G. Fadel, Optimization of an automotive radiator fan array operation to reduce power consumption, IEEE/ASME Transactions on Mechatronics 20 (2014) 2359-2369.
X.-D. He, Dynamic modeling and multivariable control of vapor compression cycles in air conditioning systems, Ph.D. thesis, Massachusetts Institute of Technology, 1996. S. P. Singh, Optimal Hotel load management in 48V Class-8 Mild Hybrid Trucks, Master's thesis, The Ohio State University, 2021.
I. H. Bell, J. Wronski, S. Quoilin, V. Lemort, Pure and pseudo-pure fluid thermophysical property evaluation and the open-source thermophysical property library coolprop, Industrial & engineering chemistry research 53 (2014) 2498-2508.
Q. Zhang, M. Canova, Lumped-parameter modeling of an automotive air conditioning system for energy optimization and management, in: Dynamic Systems and Control Conference, volume 56123, American Society of Mechanical Engineers, 2013, p. V001T04A003.
A. V. Dandekar, C. S. Brooks, Modeling of void fraction covariance in twophase flows with phase change, International Journal of Heat and Mass Transfer 100 (2016) 231-242.
P. A. Gagniuc, Markov chains: from theory to implementation and experimentation, John Wiley & Sons, 2017.

1. A method of optimized energy management, the method comprising:
creating a synthetic training dataset, wherein the synthetic training dataset comprises a plurality of activity profiles for a period of time;
training a deep learning model using the synthetic training dataset;
predicting, using the trained deep learning model, a power load for the period of time;
determining a projected state of charge (SOC) of an energy storage device during the period of time based, at least in part, on the predicted power load; and
controlling charging operations for the energy storage device based on the projected SOC.

2. The method of claim 1, wherein the deep learning model comprises a recurrent neural network.

3. The method of claim 1, wherein the deep learning model comprises a long short term memory (LTSM) model.

4. The method of any one of claims 1-3, wherein controlling charging operations for the energy storage device based on the projected SOC comprises controlling a vehicle engine.

5. The method of any one of claims 1-4, wherein creating a synthetic dataset comprises generating the plurality of activity profiles from a base dataset.

6. The method of any one of claims 1-5, wherein each of the plurality of activity profiles comprises sleep activity data and energy usage data.

7. The method of any one of claims 1-6 wherein each of the plurality of activity profiles comprises a time allocation matrix (TAM), wherein the TAM comprises temporal activity information.

8. The method of any one of claims 1-7, wherein each of the plurality of activity profiles comprises a transition matrix (TM), wherein the TM comprises relational activity information.

9. The method of any one of claims 1-8, wherein each of the plurality of activity profiles comprises a power load profile.

10. The method of any one of claims 1-9, wherein the energy storage device is one or more batteries.

11. The method of any one of claims 1-10 wherein the period of time is a hotel period for a long-haul vehicle driver.

12. The method of any one of claims 1-11, further comprising predicting an HVAC load, and wherein the predicted power load is based at least in part on the HVAC load.

13. The method of claim 12, wherein the step of determining a projected SOC comprises using dynamic programming to determine the projected SOC using the HVAC load and the predicted power load.

14. A system for optimized energy management, the system comprising:
a vehicle comprising an energy storage device, a vehicle controller, and an engine;
an energy management controller operably coupled to the vehicle, the energy management controller comprising a processor and a memory, the memory having computer-executable instructions stored thereon that, when executed by the processor, cause the processor to:
create a synthetic training dataset, wherein the synthetic training dataset comprises a plurality of activity profiles for a period of time;
train a deep learning model using the synthetic training dataset;
predict, using the trained deep learning model, a power load for the period of time;
determine a projected state of charge (SOC) of an energy storage device during the period of time based, at least in part, on the predicted power load; and
transmit the projected SOC to the vehicle controller, wherein the vehicle controller is configured to control charging operations for the energy storage device based on the projected SOC.

15. The system of claim 14, wherein the deep learning model comprises a recurrent neural network.

16. The system of claim 14, wherein the deep learning model comprises a long short term memory (LTSM) model.

17. The system of any one of claims 14-16, wherein the vehicle controller is configured to control charging operations for the energy storage device based on the projected SOC by controlling a vehicle engine.

18. The system of any one of claims 14-17, wherein creating a synthetic dataset comprises generating the plurality of activity profiles from a base dataset.

19. The system of any one of claims 14-18, wherein each of the plurality of activity profiles comprises sleep activity data and energy usage data.

20. The system of any one of claims 14-19, wherein each of the plurality of activity profiles comprises a time allocation matrix (TAM), wherein the TAM comprises temporal activity information.

21. The system of any one of claims 14-20, wherein each of the plurality of activity profiles comprises a transition matrix (TM), wherein the TM comprises relational activity information.

22. The system of any one of claims 14-21, wherein each of the plurality of activity profiles comprises a power load profile.

23. The system of any one of claims 14-22, wherein the energy storage device is one or more batteries.

24. The system of any one of claims 14-23, wherein the period of time is a hotel period for a long-haul vehicle driver.

25. The system of any one of claims 14-24, wherein the energy management controller is operably coupled to the vehicle over a communication network.

26. The system of any one of claims 14-25, further comprising predicting an HVAC load, and wherein the predicted power load is based at least in part on the HVAC load.

27. The system of claim 26, wherein the projected SOC is determined using dynamic programming based on the HVAC load and the predicted power load.
